(19) United States
(12) Patent Application Publication
(10) Pub. No.: US 2022/0378637 A1
(43) Pub. Date: Dec. 1, 2022

(54) PORTABLE MEDICAL LIFT AND POSITIONING DEVICE AND ADAPTER THEREFORE

(71) Applicant: MODERN HEALTHCARE EQUIPMENT LLC, Ft. Lauderdale, FL (US)

(72) Inventor: David Michael Wolfe, Fort Lauderdale, FL (US)

(21) Appl. No.: 17/818,886

(22) Filed: Aug. 10, 2022

Related U.S. Application Data
(63) Continuation-in-part of application No. 17/025,438, filed on Sep. 18, 2020.

(51) Int. Cl. A61G 7/10; A47C 20/02; A47C 20/00; A47C 20/04

(52) U.S. Cl. CPC A61G 7/1001; A47C 20/027; A61G 7/1063; A47C 20/021; A47C 20/042; A47C 20/023

(57) ABSTRACT

A lift and position device and adapter and methods of use therewith designed to aid attendants in moving and propping the various selected body parts of a patient from atop a support surface, for example, a mattress or hospital bed. The device utilizes a base for stability, a separately powered screw jack, radial adjustment head, a cushion cradle and a single or plurality of fitted cushion(s) configured to optimally raise and lower a particular body part of a patient such as his or her arms, torso, legs, back and the like. An adapter device may optionally re-orient the lift and positioning device, as appropriate, to suit the specific needs of an attendant wishing to the lift, shift, position or prop and secure a particular body part of a patient.

### CROSS-REFERENCE TO RELATED APPLICATIONS

This application is a continuation-in-part application of U.S. patent application Ser. No. 17/025,438 filed on Sep. 18, 2020, and entitled PORTABLE MEDICAL LIFT AND POSITIONING DEVICE, which is hereby incorporated by reference in its entirety.

### FIELD OF THE INVENTION

The disclosure relates to portable patient lifting machines. Specifically, the disclosure relates to patient lifting machines used to move a patient from one position to another in many forms and iterations therewith on a hospital bed.

### INTRODUCTION

The following is not an admission that anything discussed below is prior art or part of the common general knowledge of persons skilled in the art.

U.S. Pat. No. 9,066,842 (Partridge) discloses a lift and move device to be strapped onto a hospital bed in order to lift and move an otherwise incapacitated patient. The lift and transfer and moving device includes a sling having a flat sheet configured with edges to accommodate a side laying person's back, torso, hips and upper legs, etc. The edges of the device allow a system wherein straps may be configured to reposition and secure the side laying person and, thus, to enable service personnel to reposition a bedridden person by tugging or pulling on the straps. These straps configure to both secure and rotate the patient so an attending caregiver may roll a laying patient from side-to-side and secure a side laying person on one side or angled side until time for rotation to the other side.

Partridge reference provides an example of a lifting and moving device that is separate and distinguishable from the hospital bed to which it is attached. Thus it may be capable of being detached and attached to a variety of beds.

It is lightweight, portable, attachable and detachable to a bed, capable of lifting, rolling and moving various body parts of a patient, U.S. Pat. No. 9,066,842 performs these functions using an intricate system of belts, straps, slings and buckles.

There exists no present apparatus or system therewith that performs these same functionalities which use a mechanical jack and/or jackscrew as a patient lifting and moving device. Additionally, there exists no present apparatus or system therewith that is compatible with an adapter configured to re-arrange the lift for horizontal use.

### STATE OF THE ART

The hospital industry has been confronting an epidemic that plagues many of its staff: Tens of thousands of nursing employees suffering debilitating injuries every year, mainly from doing part of their everyday jobs—moving and lifting patients.

Nursing employees suffer more back and shoulder injuries than just about any other occupation. Workers who are relatively young have to stop working early in many cases. Often times they go home and experience pain in doing simple household endeavors such as lifting children, groceries, etc. These troubles stem from back injuries, arm injuries, and shoulder injuries suffered in the workplace.

Hospitals have reduced the number of injuries by buying special equipment to move patients and conduct intensive training to teach the staff how to use it. These efforts have in many instances dramatically reduced the instances of injury by nurses.

The need to turn from side-to-side and secure a person in positions confined to a bed with temporary or permanent loss of mobility is well known. Patient rotation from side-to-side is necessary for maintaining patient comfort, facilitating examination, and preventing bed sores from forming. Patients once moved might often need to be secured and placed in static positions wherein arms are raised, legs are elevated, backs are propped, etc. Manual lifting and turning of a bedridden patient is physically demanding for nurses, aides and others responsible for the care of the bedridden patient especially with average body weight in the industrialized world increasing annually. Such labor may result in injury to the back and other body parts of the person doing the lifting and/or turning of the patient. These injuries to nurses, aides and others result in time lost from the job, permanent disabilities, increased health care costs and litigation.

At present, the assemblies used to lift and move patients are very heavy, bulky and cumbersome. Elaborate sling systems mounted to overhead railings have been used to solve the problem of lifting and moving patients in hospitals. U.S. Pat. No. 4,117,561 relates to a wheel driven assembly outfitted with a base, and a boom out of which a sling mounts distally on a railing which extends laterally overhead. The machine can then be used to place a patient inside a sling hung by a chain or rope not unlike a child hanging from a swing set. U.S. Pat. No. 5,327,592 relates to a device which hangs stationary from a ceiling mounted swing which is powered to lift and lower by means of an electric hoist. The patient can be hoisted and lowered after being placed on a sling by one or more caregivers. Even more elaborate devices for lifting and moving patients include devices whose support structures extend a four cornered skeleton box-shape, wherein a mount can be placed overhead. Said mount can track in directions North, South, East, and West by means of elaborate wheeled assemblies. U.S. Pat. Nos. 5,337,908, and 5,511,256 by way of example describe separate incarnations of a hoist mechanism mounted to a frame which extends towards the four walls of a room. The frame itself is outfitted with various forms of rollers and track beams which allow for each respective hoist and sling to track across the room in various directions.

Moreover, assemblies for moving patients may be outfitted within the patient bed itself. Many patents provide examples of this concept in action. U.S. Pat. Nos. 7,568,240, 5,160,010, 5,173,975, 7,568,240, 4,409,695, 4,499,618, 5,105,486, 5,072,840, 5,613,255, 5,636,394, 5,687,437, 7,013,510, 7,237,286, 7,334,277, 7,441,291, 7,461,420, 8,006,332, 8,074,309, 8,104,120, are all examples of beds which are themselves devices which can perform various types of movement of the patient into a myriad of positions by means of moving any one or series of body parts vis-à-vis another body part or series of body parts.

More recently, mechanisms used to move and lift patients have become more portable. U.S. Pat. No. 6,430,761 B1 shows a device which can be wheeled into a room and has no overhead lift and carry sling. Instead it consists of a lifting column which can be lifted and lowered by means of a hand crank mechanism. A seat sling is hung from the lifting column and the patient him or herself or an attendant may place said patient on the seat sling and then move the patient on or off of a bed or wheelchair or car seat as needed. This device collapses into a portable instrument which can be moved, not unlike a piece of wheel-mounted luggage.

Another portable, highly specific patient moving device can be seen in the example of U.S. Pat. No. 8,997,276 B2. Here a boom is attached to a mast on a corner of a patient's bed. Said boom is optionally outfitted with a sling, which like the above-mentioned moving devices is capable of hoisting a patient up off of a hospital bed. The configuration of the present example allows for the patient to be rotated and consequently transferred by the boom along the vertical y-axis represented by the mast configuration.

Other mechanisms used in the industry have been proven effective but are highly specified in terms of the type of movement and/or transfer affect. For instance, 8,261,380 B2 describes a modified stretcher that is outfitted as a bed accessory. Said accessory can facilitate a prone to supine or supine to prone patient transfer. The accessory is placed adjacent to a stationary bed, and it is capable of providing a flat surface which can be tilted at any angle from 0° to 90°. This has the effect of assisting an attendant to turn a patient from supine to prone or vice versa.

Some more recent devices are mobile, multifunctional, and display modular components which may be used to lift and/or transfer patients. Modularity allows for the use of various types of moving mechanisms to be utilized to satisfy the nuances of a particular assisted movement: slings, chairs, straps, harnesses and/or transfer sheets may optionally be used. U.S. Pat. No. 8,336,133 B2 is an example of a mobile multifunctional patient transfer device wherein a lift cart is outfitted with a host of optional lift components. Once placed adjacent to a patient bed, said device may act in various capacities and be outfitted to fit a host of desired transfer motions based on the needs of the attendant. Lift components may include frontal bars, tabletops, bars, hoists, knee blocks and supports, detachable handles, safety cushion(s) and the like. Said components can assist an attendant in performing frontal transfers, lateral seated transfers, lateral bed transfers, and sit-to-stand transitions based on the needs of the attendant.

U.S. Pat. No. 5,323,498 A provides an example of an elaborate device with a series of boards capable of wedging themselves underneath a patient lying on his or her bed. The device may then tilt and/or lift the patient off of a bed so that the patient may then be placed back on the bed at a different position. Again, like many of the aforementioned mechanisms, the present device needs to be wheeled into a patient's room and subsequently placed adjacent to the bed. Similarly, a four wheeled device shown in U.S. Pat. No. 6,662,388 shows a mechanism placed adjacent to a patient's bed where an elaborate means for moving said patient is accomplished by means of sliding an object between a patient and the bed he or she is laying upon. In this instance, the object is a flat, flexible sheet. The device utilizes a lifting assembly, a base supporting said lifting assembly, a vertically adjustable shaft, a horizontal load-bearing boom-like member for attaching said horizontal load-bearing member and a generally flat, flexible sheet upon which the patient is supported.

Still others accomplish moving and/or lifting a bedridden patient by means of inflation-based technologies. U.S. Pat. No. 7,007,330 B2 is one such example. Here, the device comprises inflation bladders configured to be secured between the patient's body and the patient's bed. The bladders are inflated with pressurized fluid. The configurations of surrounding bladders and the choice of which bladders to inflate determine the direction of movement of the bedridden patient, body-part by body-part. Another, less complex example is seen in U.S. Pat. No. 4,005,498 A. Here the device is a singular inflatable pad having a control pocket formed thereon for receiving a hospital attendant's arm. The pad may be inserted underneath the patient with the control pocket and attendant's arm being positioned above the inflatable pad and in contact with the patient's body. Inflation accomplishes the goal of moving a desired part of the patient's body, such as his or her buttocks, lower back, upper back, upper leg, lower leg, knee(s), arm, head, neck and the like. Still another such example of an inflatable device can be found in U.S. Pat. No. 7,617,553 B1 wherein an inflatable device is used to specifically lift the rectal region of a bedridden patient.

There exists no ultra-portable, ultralight device for moving patients which utilizes jack and jackscrew-based foundational mechanical technologies. Likewise, there exists no ultra-portable, ultralight adapter device for re-arranging the orientation of devices utilizing jack and jackscrew-based foundational mechanical technologies.

### BRIEF SUMMARY

Briefly described, in an example embodiment, the present apparatus and method to overcome the above-mentioned disadvantage, and meet the recognized need for a body lift, positioning, propping and securing device and methods of use comprising, in general, a configured cushion(s) or series of fitted cushions induced to partially fit in an angle adjustable mount or cradle which itself may be bolted to a modified mechanical screw-type jack configured to attach to a base plate which lays flat on the patient's bed. The mount or cradle may be comprised of carbon fiber, aluminum or similar ultra-light and strong substance known in the field. The internal cradle may be shaped like a rectangular five-sided box that accepts a foundational cushion with a rectangular bottom that hangs over the internal cradle. A plurality of cushion(s) may each be respectively dimensioned to accommodate a person's back, torso, shoulder, hips, legs, and feet wherein at least one curved cushion(s) adjoined to a cradle rest upon a specified and targeted patient body part. A nurse or any patient attendant may reposition and secure the laying person into a series of desired body positions using a system comprised of a modified mechanical jack and the adjoining cradle and interchangeable cushion(s). Service personnel may reposition a bedridden person by using the mechanical jack, adjoining cradle and cushion(s) to reposition, prop and secure the laying patient from a supine or prone laying position into a new position wherein one or more body parts are lifted, raised and secured by the device. The device once set, may prevent the patient from moving from side-to-side, rolling or otherwise shifting into a position not in keeping with the attendant's desires.

In an exemplary embodiment, a body lift and positioning device and methods of use, the apparatus including a base, a joint, for example, a radial adjustment head, a mechanical jack, an internal cradle and one or more cushion(s) dimensioned to conform and contour to a particular patient body part thereon. The method including the steps of providing a body lift and positioning apparatus, the apparatus having a base capable of moving, for example, repositioning, on a bed, a mechanical jack capable of being lifted and lowered by means of a rotational device, for example, a socket driver, and contoured cushion(s) configured to fit a particular body part of a person, for example, an immobile or obese patient.

In still a further exemplary embodiment of the invention, the cushion(s) is contoured to fit underneath a patient's back. In some embodiments of the invention a plurality of cushions may be fitted onto one another and configured to conform to a patient's torso for tilting sideways. In some scenarios, for the purposes of storage and transport the cushions may seat into each other making it possible to move many body parts yet still fit the cushions in a relatively small duffel bag. In some embodiments of the invention a plurality of cushions may be fitted into one another and configured to conform to the bottom of a patient's legs to aid in circulation by raising the legs above the heart. In yet another embodiment of the invention a cushion(s) may be fitted in order to facilitate propping a patient on their side to aid in changing bed pans.

In a method of assembly of an exemplary embodiment of the device, an attendant may attach the bottom of the mechanical screw-type jack to pegs resting on the top center of a large base plate at 90-degree angles. The jack may be attached to the base plate and the joint or radially adjustable accepter head may be attached to the end of the jack's lever arm via carriage bolts (if it wasn't left on by the last user and therefore already attached to the lift). Next, the cushion mount or cradle may serve as an internal skeleton to give a cushion strength and stability as well as to give the cushion a hard upper platform to be inserted into the lift and an angle may be selected for the cradle by way of the radial adjustment head using a ball lock pin. In some embodiments, the mount's upper platform may include slots or cavities configured to receive protrusions or columns extending from the cushion(s) to secure the cushion(s) to the cradle or mount. For example, the cushion or plurality of cushions may be fitted together and attached to the cushion cradle by way of columns at the bottom of the cushions that fit into the cradle for a snug fit. Last, an attendant may select the appropriate cushion(s) or plurality of cushions. The attendant or attendants may move the device across the bed and place it partially underneath and/or adjacent to the body part that the attendant wishes to lift and prop. The attendant or attendants may manually move the patient using a strap or sling or by means of their hands alone in order to place the lift under the patient. The movement, however, will be minimal in that lifting the body part may be necessary to the extent that said body part can be placed upon the lowest setting of the mechanical jack. Once the base, lifting unit, adjustable head, cradle and appropriate cushion(s) are assembled the attendant may place the appropriate patient body part or region into the appropriate cushion(s) (top portion of the assembled device) and then, using a rotational device, for example, a powered socket driver, lift the patient's body part to any desired height within the range of the jack's capabilities.

Accordingly, a feature of the medical lift and positioning device and methods of use is its ability to enable a single attendant to comfortably maneuver, reposition, roll, lift and/or prop a body part of a large bedridden patient with no other tool needed. In some embodiments, only an accompanying strap is needed to comfortably maneuver, reposition, roll, lift and/or prop a body part of a large bedridden patient. The device itself may be designed for such ease of maneuverability. Moreover, multiple devices may be used to lift and prop more than one patient body part at a time, for example, with a bench accessory that straddles the two lifts.

Another feature of the medical lift and positioning device and methods of use is its ability to provide an efficient, lightweight, highly maneuverable and safe apparatus for the lifting, propping and repositioning of patients, for example, bedridden patients.

Another feature of the medical lift and positioning device and methods of use is a high friction rubber sheet at the bottom of the front base which enables the lift to grip the sheets. In some examples, a high-friction spray may be applied to the bottom of the front base to allow the lift to grip the sheets.

Another feature of the medical lift and positioning device and methods of use is its ability to aid healing by holding broken bones and muscles, for example, arm muscles, at specified heights and angles securely in a body part contoured cushion attached to the lift.

Still another feature of the medical lift and positioning device and methods of use is its ability to enable a single person to quickly and/or efficiently prop a bedridden patient on either of the patient's sides (e.g., to turn the patient) to maintain patient comfort, facilitate patient examination, and to prevent bed sores from forming.

Yet another feature of the adapter for a medical lift and positioning device and methods of use is its ability to provide a compact, disassemble able, light and portable apparatus that is easily stored and transported to the patient's home or hospital room.

Yet another feature of the medical lift and positioning device and adapter therefore and methods of use is their ability to assist with bedridden patient rolling, positioning, repositioning, and tilting from side-to-side as well as their ability to position, reposition and tilt a particular body part of a patient at various angles between the horizontal and vertical axis.

Yet another feature of the medical lift and positioning device and methods of use is its ability to relieve stress on the fingers, hands, arms, back, shoulders and wrists of the caregiver, especially when the patient is heavy.

Yet another feature of the medical lift and positioning device and methods of use is its ability to accommodate different sized bedridden patients.

Yet another feature of the medical lift and positioning device and methods of use is its ability to conform to a side laying patient's back, shoulder, torso, hips, and upper legs.

Yet another feature of the medical lift and positioning device and methods of use is its ability to aid during physical therapy activities by using a rotational motor to flex body parts (e.g., calves) to and fro to provide blood flow and muscle growth.

Yet another feature of the medical lift and positioning device and methods of use is the ability to easily disinfect the material used to form the lift and the cushions with over-the-counter cleaning sprays or liquids. For example, the lift may be formed of a metal or carbon fiber material and the cushions may be formed of ethylene-vinyl acetate (EVA), which may be easily disinfected by users, for example, a nurse or medical assistant. This may prevent the passage of viruses and other diseases from patients to medical personnel such as nurses.

Yet another feature of the medical lift and positioning device and methods of use is its ability to provide a low-cost alternative to systems for lifting, propping, securing and turning a bedridden patient, such as, mechanical means for lifting and turning, including mechanical rollers supported by a stationary or moveable support structure positioned above a hospital bed.

Yet another feature of the medical lift and positioning device and methods of use is its ability to provide a support assembly capable of supporting a bedridden patient in an angled position on their side to enable additional positions to rest on their side to reduce bed sores and to increase comfort of the bedridden patient.

Yet another feature of the medical lift and positioning device and methods of use is its ability to be placed at the foot of the bed on the floor, for example, at a user's home. For example, the device may be placed adjacent to a bed to support the head and/or neck of the user by use of a cushion configured for use with a face down patient, allowing the user's spine to properly align after height adjustment.

Yet another feature of the medical lift and positioning device and methods of use is its ability to be utilized with existing beds or bed frames.

Yet another feature of the medical lift and positioning device and methods of use is its ability to be easier, less expensive, smaller, lighter and simpler to use than existing technology.

Yet another feature of the medical lift and positioning device and methods of use is its independence from attachment to a ceiling, wall or floor thereby making the device capable of being freely transported and used in a wide variety of environments, including, for example, outside, on the ground, to aid a bleeding soldier by elevating the bleeding injury above the soldier's heart.

Yet another feature of the medical lift and positioning device and methods of use is its ease of assembly and disassembly and its ability to fit under a bed, or in a duffel bag for easy transport.

Yet another feature of the medical lift and positioning device and methods of use is its ability to prevent disease spread by providing medical personnel, for example, nurses, with a means to move and hold a patient without the use of the patient's or their own hands, arms or chests.

In accordance with embodiments of the present invention, an adapter may be provided for a portable medical lift and positioning device, comprising: A body member comprising a pair of arm elements, each arm element pivotally connected at a pivot point to a bridge element, the bridge element and arm elements each comprising fastening means for retaining a portion of a lift device. In some embodiments, the adapter the bridge element fastening means may comprise a bracket adapted to receive a portion of a lower support member of the lift device. In some embodiments, the arm element fastening means may comprise a pair of openings extending toward channels, each channel adapted to friction fit a leg of a lower support member of the lift device. In some embodiments, the body member may be operably connected to a base of the lift device.

In accordance with embodiments of the present invention, an adapter may be provided for a portable medical lift and positioning device, comprising: A body member, comprising: a pair of arm elements, each arm element having an elongated structure with a lift retaining member disposed on a middle section of the elongated structure, each lift retaining member comprising an opening extending toward a channel configured to retain a front portion of a lift device, and a top section of each elongated structure pivotally joined to a bridge element comprising a fastening means adapted to receive at least a rear portion of the lift device. In some embodiments, the body member may releasably connect to a base member configured to releasably connect to a lift base. In some embodiments, the adapter may be configured to rest on a footrest of a bed and enables the lift device to move a user side to side. In some embodiments, the adapter may be formed of a carbon fiber material.

In accordance with embodiments of the present invention, an adapter may be provided for a portable medical lift and positioning device, comprising: A body member, comprising: a pair of arm elements, each arm element having an elongated structure with a lift retaining member disposed on a middle section of the elongated structure, each lift retaining member comprising an opening extending toward a channel configured to retain a front portion of a lift device, and a top section of each elongated structure pivotally joined to a bridge element comprising a fastening means adapted to receive at least a rear portion of the lift device; and a base member comprising a top surface with a pair of adapter connector portions and a bottom surface with one or more openings extending toward corresponding lift base connector portions. In some embodiments, the front portion of the lift device is a front portion of a lower support member of the lift device. In some embodiments, the rear portion of the lift device may be a rear portion of a lower support member of the lift device. In some embodiments, a lower support member of the lift device may comprise two legs which intersect to form a “T” shape, and each lift retaining member is configured to receive a portion of a first support member leg, and the bridge element fastening means is configured to receive a portion of a second support member leg. In some embodiments, the bridge element fastening means is a bracket. In some embodiments, portions of the first support member leg may friction fit within each of the lift retaining members disposed on the arm elements. In some embodiments, the adapter may be configured to rest on a footrest and enables the lift device to move a user side to side. In some embodiments, the adapter may be formed of a carbon fiber material.

These and other features of the medical lift and positioning device and methods of use will become more apparent to one skilled in the art from the following Detailed Description of the Embodiments and Claims when read in light of the accompanying drawing Figures.

### BRIEF DESCRIPTION OF THE DRAWINGS

The present medical lift and positioning device and adapter therefore and their methods of use will be better understood by reading the Detailed Description of the embodiments with reference to the accompanying drawing figures, in which like reference numerals denote similar structure and refer to like elements throughout, and in which:

FIG. 1 is a perspective view of an example embodiment of the medical lift and positioning device assembly in its expanded position, showing the base attached to a lift or mechanical jack.

FIG. 2 is an exploded view of an example embodiment of the medical lift and positioning device assembly.

FIG. 3 is a perspective view of an example embodiment of a tilting torso medical lift and positioning device assembly in its collapsed position, showing a tilted torso cushion seated inside an upper back cushion coupled to the lift in accordance with an embodiment of the present invention.

FIG. 4 is a perspective view of an example embodiment of the medical lift and positioning device assembly in its collapsed position, showing an arm cushion seated inside an upper back cushion coupled to the lift in accordance with an embodiment of the present invention.

FIG. 5 is a perspective view of an example embodiment of the medical lift and positioning device assembly in its collapsed position, showing a leg cushion seated inside an upper back cushion coupled to the lift in accordance with an embodiment of the present invention.

FIG. 6 is a perspective view of an example embodiment of the medical lift and positioning device assembly in its collapsed position, showing an upper back cushion coupled to the lift in accordance with an embodiment of the present invention.

FIG. 7 is a perspective view of an example embodiment of the medical lift and positioning device assembly in its collapsed position, showing a horizontal turning cushion coupled to the lift in accordance with an embodiment of the present invention.

FIG. 8 is a perspective view of an example embodiment of the medical lift and positioning device assembly in its collapsed position, showing an ankle and calf flex cushion coupled to the lift in accordance with an embodiment of the present invention.

FIG. 9 is a perspective view of an example embodiment of the medical lift and positioning device assembly in its collapsed position, showing a therapy wedge cushion coupled to the lift in accordance with an embodiment of the present invention.

FIG. 10 is a perspective view of an example embodiment of the medical lift and positioning device assembly in its collapsed position, showing a “face down” spine aligning cushion coupled to the lift in accordance with an embodiment of the present invention.

FIG. 11 is a perspective view of an example embodiment of a bypass for a medical lift and positioning device assembly, in accordance with an embodiment of the present invention.

FIG. 12a is a side view of a first exemplary embodiment of a ground spike for a medical lift and positioning device assembly, in accordance with an embodiment of the present invention.

FIG. 12b is a side view of a second exemplary embodiment of a ground spike for a medical lift and positioning device assembly, in accordance with an embodiment of the present invention.

FIG. 12c is a side view of a third exemplary embodiment of a ground spike for a medical lift and positioning device assembly, in accordance with an embodiment of the present invention.

FIG. 13 is a bottom perspective view of an exemplary “face down” spine aligning cushion, in accordance with an embodiment of the present invention.

FIG. 14 is a perspective view of an exemplary disassembled “face down” aligning cushion, in accordance with an embodiment of the present invention.

FIG. 15 depicts an example embodiment of a medical lift and positioning device assembly in use, wherein an exemplary arm cushion is seated inside an exemplary upper back cushion which may be coupled to the lift to prop up or support an arm of a user in accordance with an embodiment of the present invention.

FIG. 16 depicts an example embodiment of a tilting torso medical lift and positioning device assembly in use, wherein an exemplary a tilted torso cushion is seated inside an upper back cushion which may be coupled to the lift and used to support a user back in accordance with an embodiment of the present invention.

FIG. 17 depicts an example embodiment of a medical lift and positioning device assembly in use, wherein an exemplary therapy wedge cushion is coupled to the lift to support user legs in accordance with an embodiment of the present invention.

FIG. 18 depicts an example embodiment of a medical lift and positioning device assembly in use, wherein an exemplary horizontal turning cushion is coupled to the lift to position or support a user back in accordance with an embodiment of the present invention.

FIG. 19 depicts an example embodiment of an adapter for a medical lift and positioning device in an exemplary closed position, in accordance with an embodiment of the present invention.

FIG. 20 is a perspective view of an example embodiment of an adapter for a medical lift and positioning device in an exemplary open position, in accordance with an embodiment of the present invention.

FIG. 21 is a perspective view of an example embodiment of an adapter and a medical lift and positioning device, in accordance with an embodiment of the present invention.

FIG. 22 is a perspective view of an example embodiment of an adapter and a medical lift and positioning device with the adapter in an exemplary open position, in accordance with an embodiment of the present invention.

FIG. 23 is a partially exploded, perspective view of an example embodiment of an adapter and a medical lift and positioning device showing the adapter in an exemplary closed position, in accordance with an embodiment of the present invention.

FIG. 24 depicts an example embodiment of a self-adjustment medical lift and positioning device assembly in use, wherein an exemplary foot, calf, hamstring flex cushion coupled to the lift and, for example, to allow for user self-adjustment in accordance with an embodiment of the present invention.

FIG. 25 depicts an example embodiment of a lower back decompression medical lift and positioning device assembly in use, wherein an exemplary leg cushion coupled to the lift and, for example, to allow for lower back decompression and knee-bending healing in accordance with an embodiment of the present invention.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION OF THE DRAWINGS

In describing the exemplary embodiments of the present disclosure specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

In accordance with embodiments of the present invention, a lift and positioning device may include a base, a lift, a joint or radial adjustment head, and a cushion mount. In some embodiments, the distance between the base and the cushion mount of the lift is adjustable. In some embodiments, the lift may be configured to move the cushion mount along a vertical axis. In some examples, an adapter may be utilized to change the orientation of the lift device such that the cushion mount may become movable along a horizontal axis.

In accordance with embodiments of the invention, an adapter may be configured to be compatible with the lift device to form a horizontal use assembly. In some embodiments, an adapter may be attachable to the lift device, for example, connectable to at least one component of the lift device. In any embodiment, any portion of the adapter may be made from any single or combination of sturdy materials, such as carbon fiber, polymer, resin, and plastic, Kevlar, forged metals, wood and the like.

In accordance with embodiments of the present invention, an adapter may be utilized to change the orientation of the lift device. In some examples, changing the orientation of the lift device may change the application of the device, for example, from being utilized to move a body part or person along a vertical axis (e.g., up and down), to being utilized to move a body part or person along a horizontal axis (e.g., side to side).

In some embodiments, an adapter may be configured as an intermediary component, connecting the lift to the base. For example, a portion of the adapter may be configured to connect or engage with, or hold the base of the lift, and another portion of the adapter may be configured to engage or connect with, or hold, at least a portion of the legs or bars of the lower support member.

In accordance with embodiments of the present invention, an adapter may comprise an adapter base and an adapter body.

In accordance with embodiments of the present invention, the adapter base may comprise a platform element configured as a thin plate comprising a bottom side and a top side, a lift base connector portion, and an adapter body connector portion.

In accordance with embodiments of the present invention, the bottom side of the adapter base may be substantially flat and may comprise one or more connection points, for example, one or more openings or sockets adapted to receive one or more pegs of the lift base, to support connection of the adapter base to the lift base. In accordance with embodiments of the present invention, the adapter base may be used alone or in conjunction with the lift base. For example, in some embodiments, the adapter base may be configured to mount on or otherwise couple or connect to the lift base, whereas in some embodiments, the adapter base may be a standalone component which may be configured to support the weight of the adapter component and/or the lift device connected thereto.

In accordance with embodiments of the present invention, the top side of the adapter base may comprise a lift base connector portion and one or more adapter connector portions, for example, a pair of adapter connector portions. In some examples, the base connector portion and the one or more adapter connector portions may protrude from a top side of the adapter base.

In some examples, the lift base connector portion may comprise one or more connector components, for example, four connector components which protrude from the adapter base, each connector component comprising a hollow opening configured to receive and/or retain the pegs of the lift base. In some examples, each connector component may be integrally formed with the platform element of the adapter base, or may be permanently or removably attached to the platform element, for example, by means of adhesives, screws, pins, and any other permanent or removable attachment means. In some examples, the openings or sockets of the adapter base bottom side may extend towards the adapter base lift base connector portion, for example to the one or more connector components which may protrude from the top side of the adapter base. In some examples, the adapter base may comprise a predetermined amount of sockets and/or connector components. For example, the adapter base may comprise sockets and/or connector components corresponding to the number of pegs in the lift base. In some examples, the sockets and/or connector components may be less than or may exceed the number of pegs in the lift base. In some examples, the connector components may be standalone components or may connected to (e.g., attached to or integrally formed with) one or more additional connector components, for example, to improve stability of the connection between the adapter base and the lift base. In some examples, the connector components may be generally cylindrical, however, in any embodiment, the connector components may be formed in any shape suitable to have a hollow opening and/or channel disposed therein for supporting connection to the lift base.

In accordance with embodiments of the present invention, the adapter connector portions may protrude from the top side of the adapter base. In some examples, the adapter connector portions may comprise one or more, for example, two, protruding connector elements, for example, sequentially layered according to size (e.g., larger to smaller). In some examples, the protruding connector elements may be substantially rectangular (e.g., rectangular prisms) and may have rounded corners. In scenarios with two protruding connector elements, the protruding connector elements may be arranged with, for example, a first protruding connector element protruding from the top surface of the adapter base, and a second, smaller protruding connector element, protruding from a top surface of the first protruding connector element. In some examples, a slot or groove may be formed between a first protruding connector element and a second protruding connector element and may be adapted to receive an end portion of an arm element. For example, a generally hollow arm element may comprise a thin-walled and substantially rectangular end portion (with optional rounded corners) which may be configured to correspond to, and fit within, the slot or groove formed between the first and second protruding connector elements to support securement of an arm element to a protruding connector portion (e.g., such a thin-walled substantially hollow end portion of the arm element may fit snugly within the slot or groove on the adapter connector portion to support securement of the arm element to the adapter base). In any embodiment, the protruding connector elements may be generally rectangular (e.g., rectangular prism) or may have any other suitable three-dimensional shape, including cylindrical, cube, hexagonal, ovular, spherical, or any other similarly suitable three-dimensional shape. In some embodiments, the protruding connector elements may comprise connector pins and/or receiving holes corresponding to receiving holes and/or connector pins disposed on the arm elements. For example, the protruding connector elements may comprise one or more, for example, two, receiving holes configured to support attachment of the adapter body to the protruding connector elements, for example, by corresponding in shape to and adapted to be received by corresponding connector pins disposed on the arm elements. In some scenarios, the receiving holes may be substantially hexagonal in shape, however, in any embodiment, the receiving holes may have any other similarly suitable shape, including circular, ovular, square, rectangular or any other shape. Moreover, for example, the protruding connector elements may comprise one or more connector pins configured to support attachment of the adapter body to the protruding connector elements, for example, by corresponding in shape to and adapted to be received by receiving holes disposed on the arm elements. In some examples, connector pins may comprise a substantially cylindrical body portion and a substantially rounded top portion and may protrude from and/or may be formed with or otherwise connected to the protruding connector elements. In any embodiment, the connector pins may be any similarly suitable shape, for example, rectangular, hexagonal, or square shapes. In preferred embodiments, the connector pins and receiving holes correspond to each other in shape.

In accordance with embodiments of the present invention, the adapter body may comprise one or more arm elements and one or more bridge elements. In some embodiments, the arm elements may be substantially rectangular elongated blocks. In any embodiment, the arm elements may be formed in any other similarly suitable shape, for example, a generally cylindrical, hexagonal, or any other geometrically suitable shape.

In accordance with embodiments of the present invention, the bridge element may comprise one or more lift fastening means. In some embodiments, the lift fastening means may be a clamp implement, a snap locking implement, a pressure fit implement, a magnet implement, or any combination of the foregoing. For example, the lift fastening means may comprise a pair of tensioned protruding portions forming a clamp. The lift fastening means may be configured to support connection of the adapter body to the lift device, for example, at the lower support member of the lift device. In some examples, the lift fastening means may be a clamp member or snap locking member adapted to receive, clamp or snap fasten a portion of the t-shaped component of the lift device to the bridge element of the adapter body.

In accordance with some examples, the adapter body may comprise a pair of arm elements operably connected to a bridge element. In some examples, the arm elements may be pivotally connected to the bridge element. For example, a top portion of each arm element may be pivotally connected to an end of the bridge element by means of a pivoting mechanism. In some examples, a pivoting mechanism may comprise a slot, or series of slots, in the arm elements and a pin configured to travel in the slot(s) formed in the arm elements. In some examples, the slot(s) may be “L” shaped, or any other shape. In an illustrative example, a pin disposed between first and second opposing walls of a bridge element may be configured to travel in an “L” shaped slot formed in an arm element, to support pivoting of an arm element about an axis formed at an end of the bridge element. The range of movement of the pin(s) disposed at the ends of the bridge element may be defined by the slots formed at the top ends of the arm elements. In some examples, the opposing sidewalls of an arm element may be configured to rotate between opposing sidewalls of a bridge element. In some examples, the bridge element may be configured to connect to (e.g., releasably and/or permanently) to a top portion of the arm elements. For example, the bridge element may connect a first arm element to a second arm element at their respective top portions. In any embodiment, the bridge element may connect the arm elements at any other portion of the arm elements, for example, at a middle portion or a bottom portion of the arm elements. In some embodiments, the bridge element may be permanently or releasably connected to the arm elements, for example, through the use of screws, pins, adhesives, and any other similarly suitable fastening means.

In accordance with embodiments of the present invention, one or more lift leg retaining members may be disposed on or connected to (e.g., permanently or removably) to each arm element. For example, each arm element may comprise a leg retaining member configured to retain an end portion of the lower support member of the lift device. In some embodiments, the leg retaining members may be configured to house an end portion of the lower support member legs or bars, and/or may include a fastening means to fasten the end portions of the legs or bars of the lower support member to the leg retaining members. In some examples, the leg retaining members may comprise an opening and/or channel configured to retain an end portion of the lower support member. In some examples, the opening and/or channel may substantially correspond in shape to an end portion of the legs of the lower support member, for example, the opening may be substantially square or rectangular shaped to accommodate the legs of the lower support member being similarly square or rectangular shaped. In some examples, an end portion of the legs of the lower support member may be received in and may snap or pressure fit within a cavity or channel in the leg retaining member. In some examples, any similar fastening mechanism may be utilized to secure the leg retaining members to the end portions of the legs of the lower support member.

In accordance with embodiments of the present invention, the adapter body may be a singular component (e.g., integrally formed with the arm elements and/or the bridge element). In some embodiments, the adapter body may comprise several individual components attached together (either permanently or releasably).

In accordance with embodiments of the present invention, the adapter body may be configured to connect to the lift device at or near at least two sections of the lift device, for example, at a first section of the lower support member of the lift device and at a second section of the lower support member of the lift device. In some examples, a first section of a lower support member, for example, a first section of a T-shaped lower support member, may connect to the fastening means at the bridge element, for example, at least one connection point on the bridge element, and a second section of the of the lower support member may connect to the arm elements of the adapter body at one or more connection points, for example, two connection points, with each connection point disposed on a leg retaining member of the arm elements. In some examples, a leg of the lower support member may secure to the arm elements of the adapter body by means of a pair of openings and/or channels formed in the leg retaining members, each opening/channel adapted to receive and/or snap or pressure fit a portion of a leg of a lower support member.

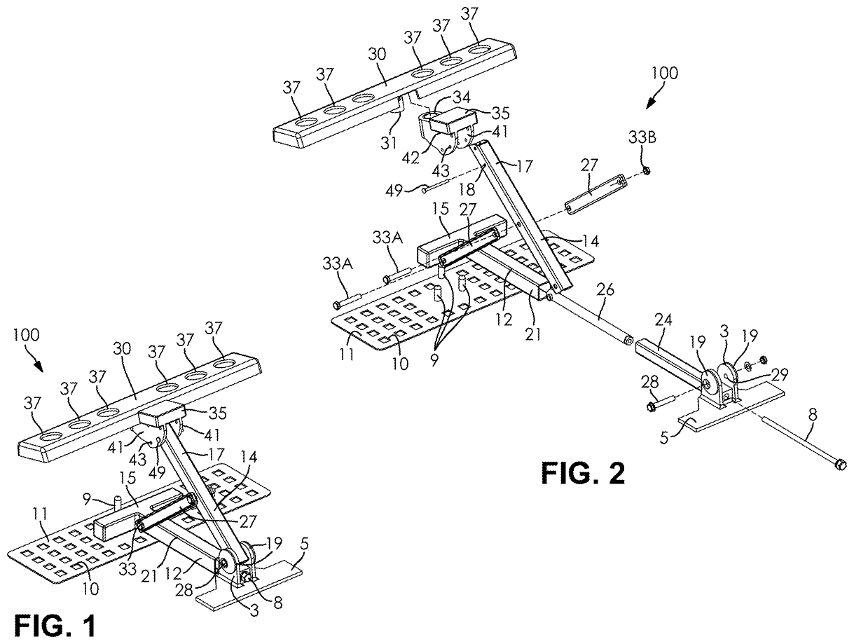

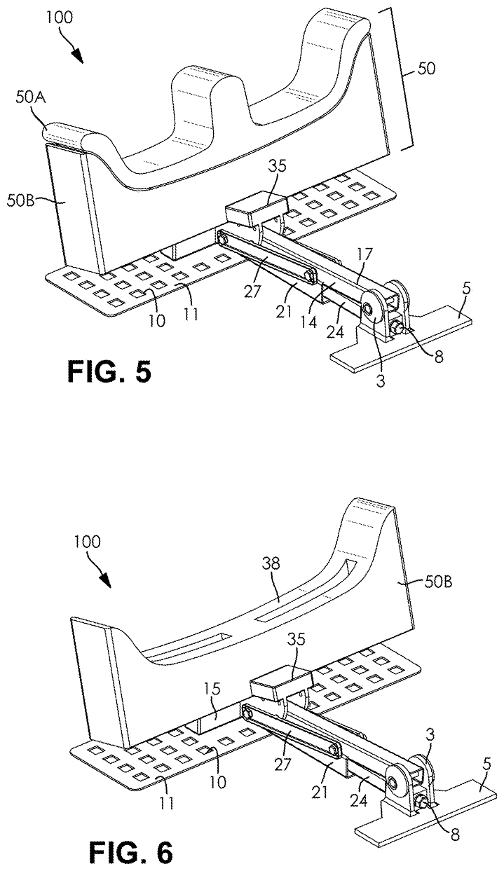

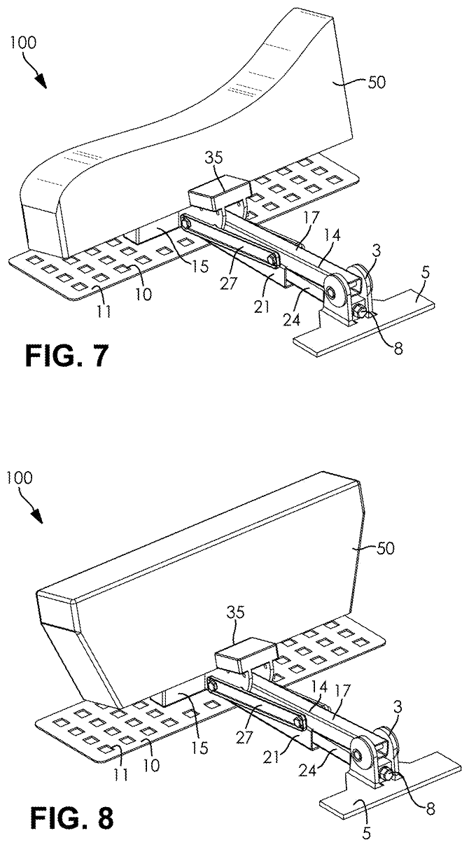

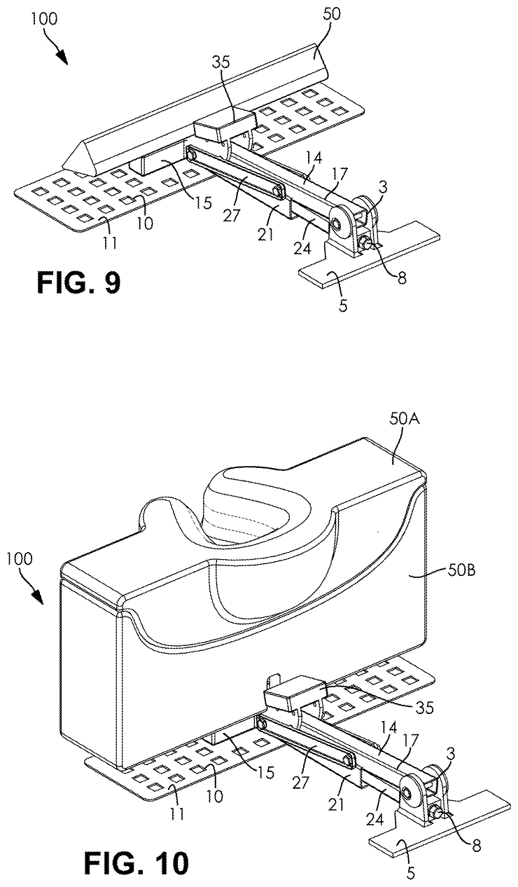

Turning now to the figures, FIGS. 1-18 generally depict a lift and positioning device in accordance with embodiments of the present invention.

In accordance with embodiments of the present invention, a lift and positioning device 100 may comprise a base 11, a lift 14, a joint or radial adjustment head 41, and a cushion mount 30.

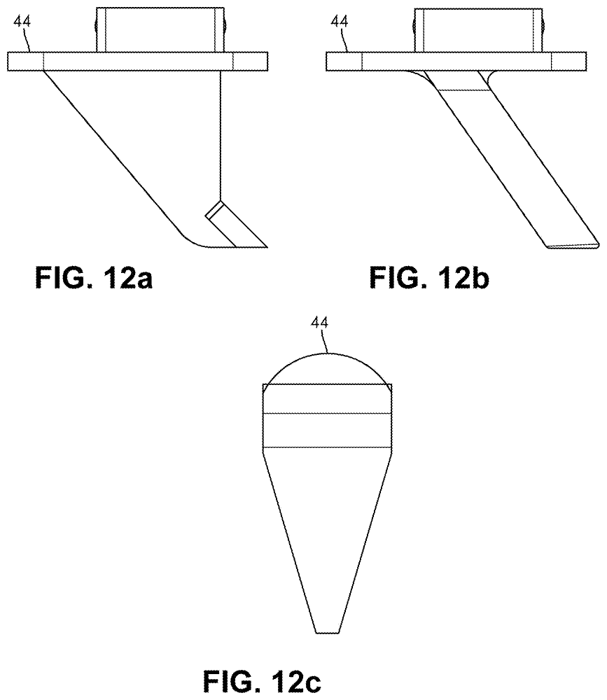

Referring now to FIG. 1, by way of example, and not limitation, there is illustrated an exemplary embodiment of a medical lift and positioning device 100. As shown in FIG. 1, a medical lift and positioning device 100 may include a front base or base plate 11. The front base 11 may be rectangular in shape and horizontally configured to lay at rest upon a bed (not shown here). In any embodiment, the base or base plate 11 may be formed in any suitable shape including, for example, circular, oval, square, diamond or hexagonal. In an exemplary embodiment, the base plate 11 may be thin and configured to approximate 6 inches wide and 16 inches in length. The configuration is subject to change within a range reasonable to one skilled in the art. The base plate 11 may be made from any single or combination of sturdy materials, such as carbon fiber, polymer, resin, and plastic, Kevlar, forged metals, wood and the like. In some embodiments, the base 11 may be permanently attached to the lift 14. In some embodiments, the base 11 may be releasably attached to the lift 14. In some embodiments, the lift 14 may be configured to swivel or rotate relative to the base 11. In some embodiments, the base 11 may include one or more lift attachment points. In some embodiments, the lift attachment points may be configured as pegs 9. In some embodiments, the pegs 9 may be bullet shaped. In some embodiments, the base plate 11 may be formed with a plurality of perforations 10. In some examples, the perforations 10 may be configured to receive spike members 44 (shown in FIGS. 12a-12c) adapted to secure the base 11 to a support surface, for example, a field, while the device 100 is in use. The spike members 44 may be formed with a sharp end and an attachment end. The sharp end may be configured to be inserted into the support surface, for example, a field or section of the ground, and the attachment section may be inserted into a perforation 10 to connect the spike member 44 to the bottom of the base 11. In some embodiments, the attachment section of the spike members 44 includes a pair of tabs configured to pinch a perforation side wall in order to reversibly secure a spike member 44 to the perforation 10. As shown in FIGS. 12a-12c, the spike members 44 may be configured in a plurality of configurations wherein the top end of the spike member 44 is formed with an attachment component and the bottom end is formed with a sharp component.

Upon the base plate 11 may lay a lift 14. In some embodiments, the mechanical jack or “lift” 14 may be reversibly coupled to the base plate 11. In accordance with embodiments of the present invention, a lift 14 may comprise a lower support member 12, a screw 8, a rear base 5, a pivot module 3, a lever arm 17, and one or more bracket members 27. In some embodiments, a lift 14 may include a joint 35 configured to connect to a cushion mount 30.

FIG. 2 shows an exploded view of an example embodiment of a medical lift and positioning device assembly. As shown in FIG. 2, the lower support member 12 part of the lift 14 may reversibly couple to the base plate 11. In some examples, an intermediary component, for example, an adapter 101 may reversibly couple the lower support member 12 to the base plate 11. In some examples, the lower support member 12 may comprise one or more legs or bars. A first leg 15 may have one or more holes (not shown) on its bottom wherein one or more pegs 9 of the base 11 may be fitted in the first leg 15. As shown in the depicted example, the support section may be “T” shaped. For example, protruding from a middle section of the first leg 15 may be a second leg 21. In any embodiment, the support section may be formed in any other configuration suitable of supporting the lift 14.

As further shown in FIG. 2, the second leg 21 of the lower support member 12 may be configured as a shaft having one or more telescoping components. For example, the second leg 21 may be formed as an external shaft and may house an internal shaft 24 which may be extended or shortened as it protrudes from the second leg 21. In some embodiments, the internal shaft 24 may include a hollow internal component 26, for example, a hollow internal chamber having an internal threaded portion.

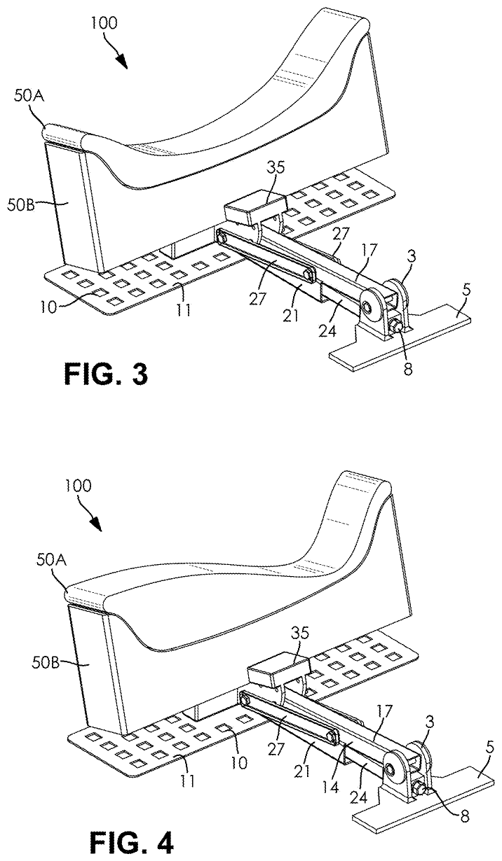

In accordance with embodiments of the present invention, the screw 8 of the lift 14 may be formed with an external threaded portion adapted to engage with an internal threaded portion within the lower support member 12. For example, the screw 8 may be configured to engage with the internal thread of the hollow internal chamber 26. In accordance with embodiments of the present invention, the lift may be moved from a first position, wherein the lift is in its collapsed form (as shown in FIGS. 3-10, for example), to a second position, wherein the lift is in its partially to fully expanded position (as shown in FIG. 1, for example), by threadably engaging the screw 8 with the internal chamber 26 of the lower support member 12, for example, by rotating or tightening the screw 8, to draw the internal shaft 24 towards the external shaft 21 and direct the rear base 5, which is disposed a distance away from the front base 11, closer towards the front base 11. In any embodiment, the screw 8 may be replaced with a similarly suitable adjustment member similarly capable of adjusting the length of the telescoping components of the lower support member 12 to draw the rear base 5 towards the front base 11.

In accordance with embodiments of the present invention, the device 100 may include a rear base 5. In some embodiments, the rear base 5 is disposed a distance from the front base 11, and includes a pivot module 3. The rear base 5 may further be coupled to the rear section of the lower support member 12.

In accordance with embodiments of the present invention, the device 100 may include a pivot module 3. In some embodiments, the pivot module 3 may include a pivot axis 29 about which the lever arm 17 may rotate or pivot. The pivot module 3 may comprise a pair of opposing plates 19 configured to flank the lever arm 17. In some embodiments, the lever arm 17 may be disposed between the opposing plates 19, and may be pivotally fastened at the pivot axis 29 to each of the plates 19 of the pivot module 3 by use of a bolt, screw, pin, for example, a ball lock pin, or any other similarly suitable removable fastener. In the depicted example, a bolt 28 and nut 29 are used to pivotally connect the lever arm 17 to the pivot module at the pivot axis 29. In the illustrated example, a lower portion of the lever arm 17 is pivotally connected to the pivot module 3 and an upper portion of the lever arm 17 is operably connected to the mount joint 35. The mount joint 25 may be referred to herein as the radial adjustment head. In any embodiment, any similar pivotable attachment means capable of permitting the lever arm 17 to pivot about the pivot axis 29 may be used to facilitate the pivoting movement of the lever arm 17 about the pivot axis 29.

In accordance with embodiments of the present invention, the lift 14 of the device 100 may include one or more bracket members 33. As shown in FIGS. 1-10, a pair of bracket members 27 may flank the second leg 21. The pair of bracket members 27 may each pivotally attach at a first point to a front section of the second leg 21 and at a second point to a middle section of the lever arm 17. In some embodiments, connector members connect the bracket members 27 to the second leg 21 and the lever arm 17. In some embodiments, the connector members may be bolts 33a and nuts 33b. In any embodiment, other suitable connector members, including screws, pins, for example, ball lock pins, and similar connectors may be used to pivotally connect the bracket members 27 to the second leg 21. In some embodiments, the bracket members 27 define a movement boundary for the lever arm 17. For example, the bracket members 27 may permit the lever arm 17 to pivot about the pivot axis 29 of the pivot module 3 within the range delineated by the bracket members 27.

In accordance with some embodiments of the present invention, the lift 14 may include a joint 35. The joint 35 may be operably connected to a top portion of the lever arm 17. In some embodiments, the joint 35 connects the lever arm 17 to the cushion mount 30. For example, the joint 35 may include an opening or slot 34 which corresponds in shape and size to the protruding portion 31 disposed on a bottom side of the mount 30, the slot 34 and the protruding portion 31 adapted to secure the mount 30 to the joint 35. In some embodiments, the joint 35 is fixed. In some embodiments, the joint 35 is radially adjustable. For example, the angle of the joint 35 may be changed to adjust the angle of the cushion mount 30. The joint may include a pair of opposing side walls 41 which flank the lever arm 17. Each side wall 41 may include one or more slots or holes configured to align with matching slots or holes 18 on the lever arm 17. As shown in FIG. 2, a first pair of slots 42 in each of the side walls 41 may be configured as a pivot point for the lever arm 17, while the remaining slots 43 may be configured as angle adjustment points for the joint 35. Pins 49, for example, ball lock pins, may be inserted into the holes 42 and 43 in the side walls 41 of the joint 35, as well as the holes in the lever arm 17 disposed between the side walls 41 in order to reversibly lock joint 35 in a selected position. For example, a first ball lock pin 49 may be configured as a pivot pin, around which the joint 35 may be configured to pivot. A second ball lock pin 49 may be configured as an angle locking pin, which may be used to lock the joint 30 in a selected position or angle relative to the lever arm 17. To change the angle of the joint 35, the angle locking pin 49 may be removed to enable free movement of the joint 35, and the angle locking pin 49 may be inserted into the holes 42 in the joint side walls 41 and the holes 18 in the lever arm 17 which correspond to a second or new joint angle.

Note that the lift, like the base plate, as well as any of its component parts may be made from any single or combination of sturdy materials, such as carbon fiber, polymer, resin, plastic, Kevlar, forged metals, wood and the like.

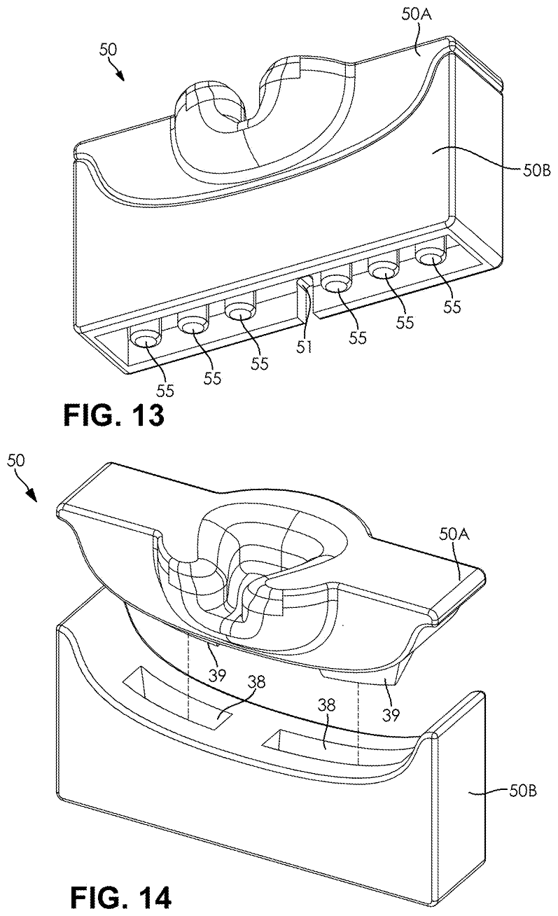

In accordance with embodiments of the present invention, a lift and positioning device 100 may include a cushion mount 30. The cushion mount 30 may include a protruding portion 31 corresponding in shape and size to an opening or slot 34 in the joint 35. Connection of the protruding portion 31 with the opening or slot 34 facilitates the secure connection of the mount 30 with the joint 35. In some embodiments, the mount 30 may be configured as an elongate bar. The mount 30 may include one or more cushion connection points adapted to connect a cushion 50 to the mount 30. For example, the mount 30 may include one or more slots or hollow spaces 37, for example, circular hollow slots, adapted to engage with and snugly fit the tubular-shaped protruding components 55 (as shown in FIG. 13) formed on a bottom side of the cushions 50.

Like the base plate and the lift, the mount may be made from a host of sturdy materials, such as carbon fiber, polymer, resin, and plastic, Kevlar, forged metals, wood and the like.

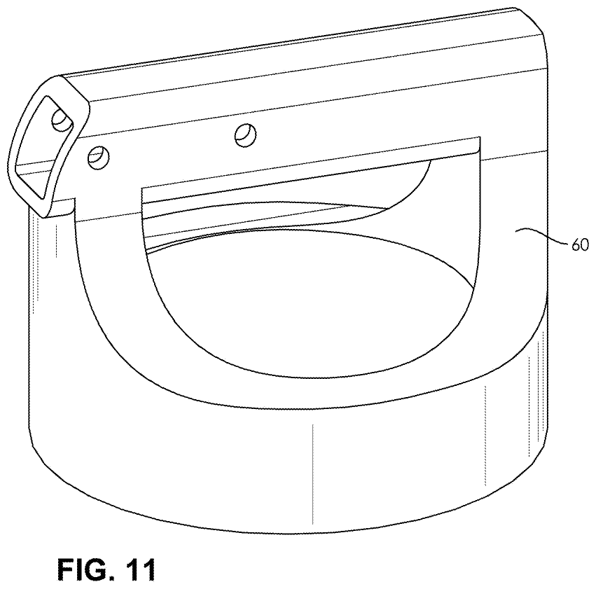

FIG. 11 is a perspective view of an example embodiment of a bypass for a medical lift and positioning device assembly, in accordance with an embodiment of the present invention. As shown in FIG. 11, in some embodiments, the bypass 60 may be configured to maintain a static height. In some embodiments, the bottom of the bypass 60 may be configured with attachment points for connection of the bypass 60 to the base 11. For example, the attachment points may be holes or openings configured to receive the pegs 9 disposed on the base 11 (as shown in FIG. 1).

In accordance with embodiments of the present invention, the lift and positioning device 100 may be configured to couple to one or more cushions 50. In some scenarios, the cushions 50 may be configured to fit over the cushion mount 30. For example, a bottom side of the cushions 50 may be formed with a cavity adapted to house at least a portion of the cushion mount 30. As shown in FIG. 13, in some embodiments, one or more protruding connectors, for example, one or more tubular-shaped protruding components 55, on the bottom side of the cushions 50 may fit snuggly into one or more slots or hollow spaces 37, for example, circular hollow slots, in the mount 30. In accordance with embodiments of the present invention, this configuration of the tubular-shaped protruding components 55 in the cushions which correspond to the slots or hollow spaces 37 in the mount 30 facilitates the easy attachment and securement of a cushion or cushions 50 to the mount 30 without the need for bolts, pins, snaps or ties that make assembly complex and time consuming. In some embodiments, one or more side walls of the cushions 50 may be formed with a hollow cavity, within which the one or more protruding connectors, for example, one or more tubular-shaped protruding components 55, may be disposed. In some scenarios, the hollow cavity creates internal walls which are adapted to frame the one or more external walls of the mount 30 when the cushion or cushions 50 are installed upon the mount 30.

As shown in FIGS. 3-10, in accordance with some embodiments of the present invention, a cushion 50 may be comprised of one or more cushion members. For example, a cushion 50 may be comprised of a top cushion member 50a and a bottom cushion member 50b. As shown in FIGS. 13-14, in some embodiments, a bottom side of the bottom cushion member 50b includes a gap 51 adapted to connect with the cushion mount 30 or the joint 35 in order to secure the cushion 50 to the mount 30 or the lift 35, respectively. As further shown in FIGS. 13-14, in some examples, a top side of the bottom cushion member 50b may include one or more block slots 38 which correspond to, and are configured to secure to, protruding blocks 39 disposed on the bottom side of the top cushion member 50a. In some examples, the connection of the protruding blocks 39 to the block slots 38 assists in securing the top cushion member 50a to the bottom cushion member 50b.

As further shown in FIGS. 3-10, the cushions 50 may be configured in a plurality of suitable shapes in order to support various patient body parts in various patient positions. For example, a top side of the cushion may be configured with one or more undulations configured to receive, position, or lift a patient arm. Any portion of cushion may be formed with one or more undulations configured to receive, position or lift a patient head, hip, neck, foot, or any other patient body part.

The cushions 50 used in conjunction with the lift and positioning device may be made from any substance known in the art such as ethylene-vinyl acetate (EVA), viscoelastic orthopedic and posturepedic memory foams, spring cushions, Low-resilience polyurethane, Sorbothane, Neoprene and the like.

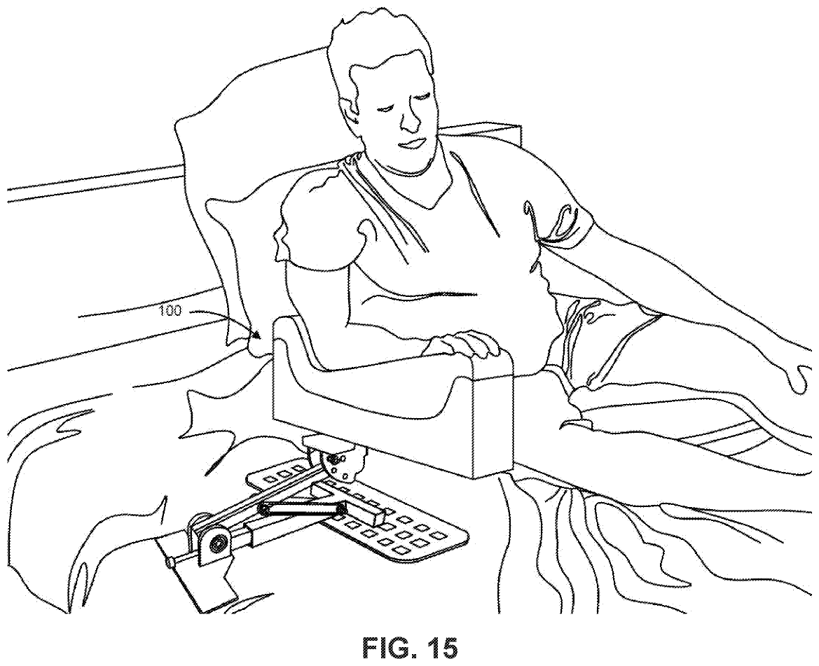

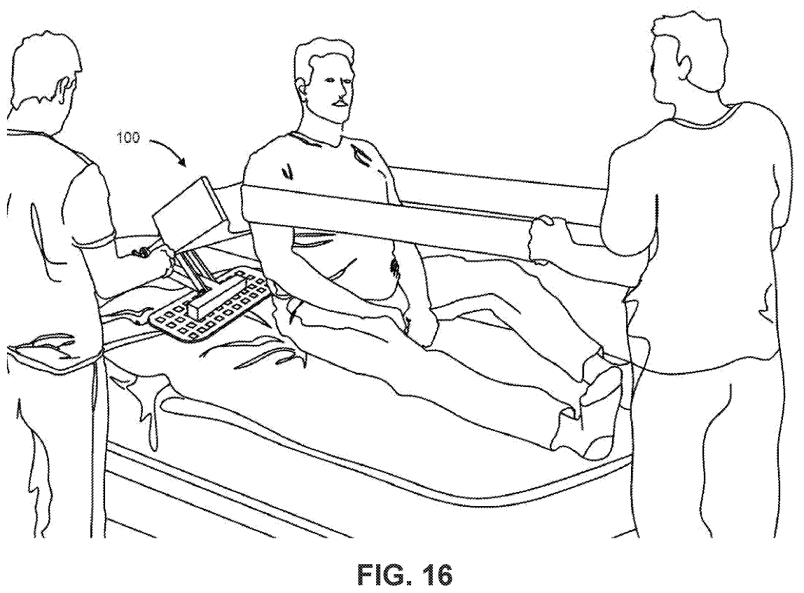

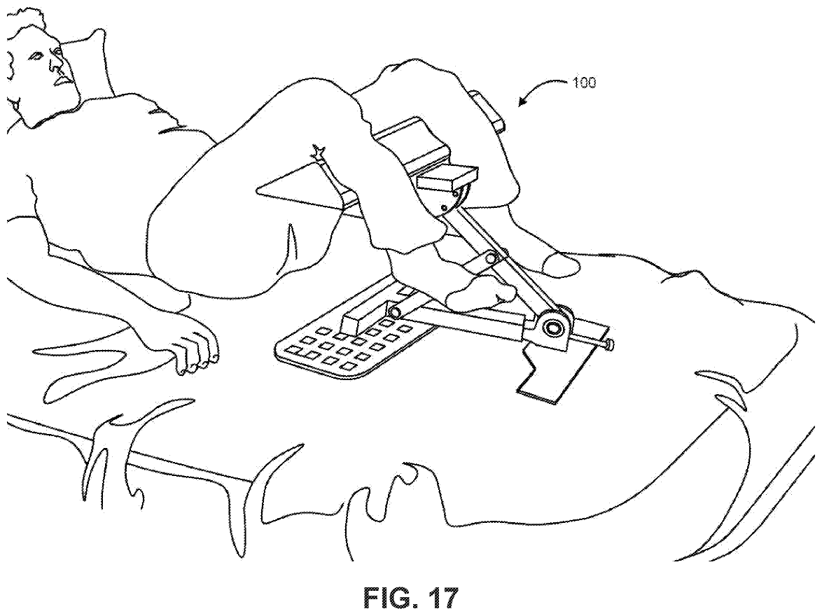

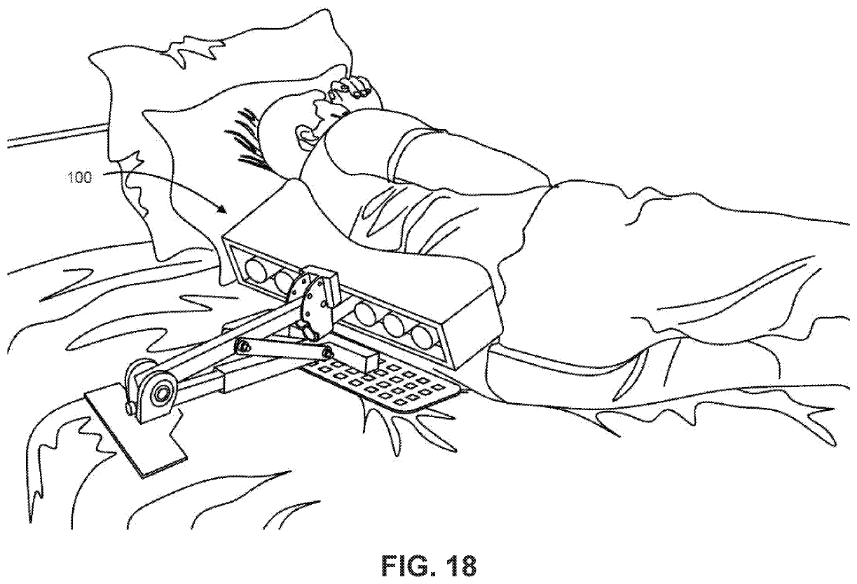

FIGS. 15-18 demonstrate various exemplary usage scenarios of the lift and positioning device 100. Specifically, FIG. 15 depicts an example embodiment of a medical lift and positioning device assembly 100 in use, wherein an exemplary arm cushion 50a is seated inside an upper back cushion 50b which may be coupled to the lift 14 to support a user arm, in accordance with an embodiment of the present invention. FIG. 16 depicts an example embodiment of a tilting torso medical lift and positioning device assembly 100 in use, wherein an exemplary tilted torso cushion 50a is seated inside an upper back cushion 50b which may be coupled to the lift 14 and used to support a user back, in accordance with an embodiment of the present invention. FIG. 17 depicts an example embodiment of a medical lift and positioning device assembly 100 in use, wherein an exemplary therapy wedge cushion 50 is coupled to the lift 14 for use in supporting user legs in accordance with an embodiment of the present invention. FIG. 18 depicts an example embodiment of a medical lift and positioning device assembly 100 in use, wherein an exemplary horizontal turning cushion 50 is coupled to the lift 14 to support a user back in accordance with an embodiment of the present invention.

As shown in FIGS. 15-18, in some exemplary usage scenarios, the lift and positioning device 100 may be utilized by placing the device 100 on a support surface, for example, a bed. In some scenarios, the device may be placed on the support surface in its first position, for example, in its collapsed form (as shown in FIGS. 3-10). In its collapsed form, the device 100 may easily be placed under the patient, for example, under a selected patient body part, for example, a patient leg. Once positioned in a selected location, the device 100 may be selectively expanded by a medical professional, for example, a nurse, doctor, or medical assistant.

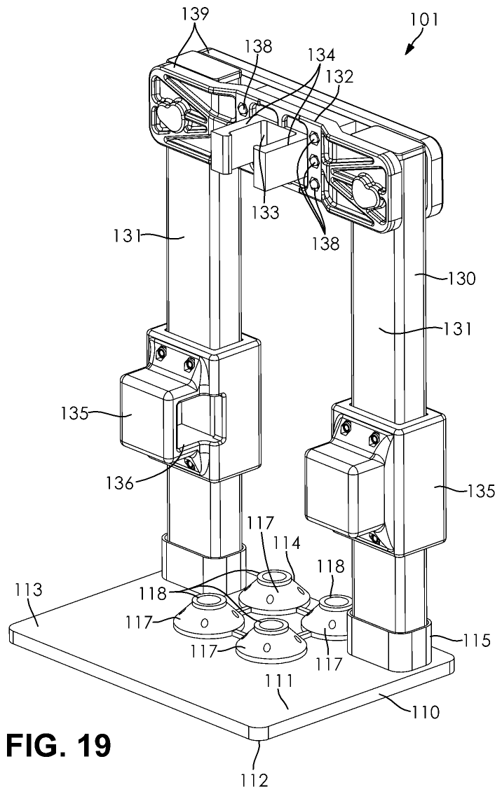

FIGS. 19-25 depict an exemplary adapter and/or lift device in accordance with embodiments of the invention. As shown in FIGS. 19-25, an adapter 101 may be configured to be compatible with the lift device 100. In some embodiments, an adapter 101 may be attachable to the lift device 100, for example, connectable to at least one component of the lift device 100.

Like the base plate and the lift, the adapter and/or any portion thereof may be made from any single or combination of sturdy materials, such as carbon fiber, polymer, resin, and plastic, Kevlar, forged metals, wood and the like.

As shown in the figures, an adapter 101 may be utilized to change the orientation of the lift device 100. In some examples, changing the orientation of the lift device 100 may change the application of the device, for example, from being utilized to move a body part or person along a vertical axis (e.g., up and down), to being utilized to move a body part or person along a horizontal axis (e.g., side to side).

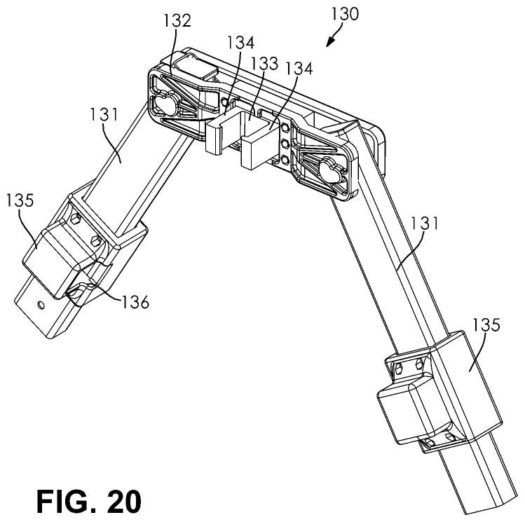

FIGS. 19-23 depict an adapter (or portions thereof) alone or in combination with a lift device in accordance with embodiments of the present invention. As shown in FIG. 19, an adapter 101 may comprise an adapter base 110 and an adapter body 130. As shown in FIG. 20, an adapter body 130 may comprise a pair of arm elements 131 pivotally connected to a bridge element 132.

As further shown in FIG. 19, the adapter base 110 may comprise a platform element 111 configured as a thin plate comprising a bottom side 112 and a top side 113, a lift base connector portion 114, and an adapter body connector portion 115.

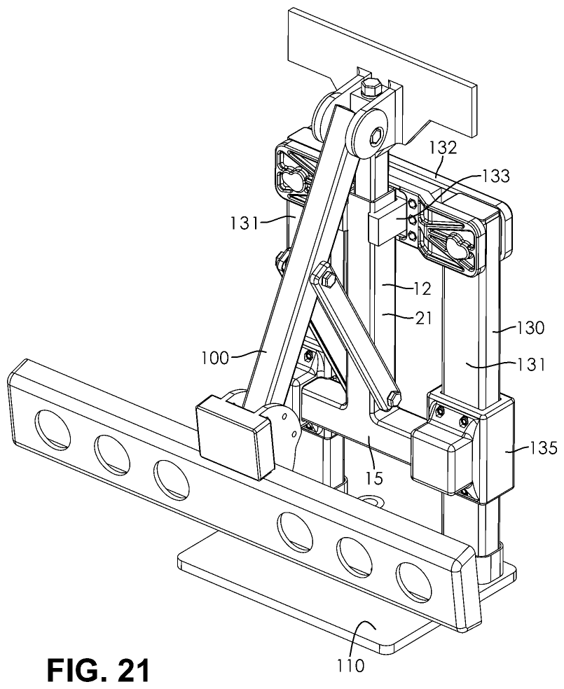

As shown in FIG. 21, an adapter 101 may be configured as an intermediary component and may be disposed between and/or connect the lift 14 and the base plate 11. For example, a portion of the adapter 101 may be configured to connect or engage with, or hold the base plate 11 of the lift 14, and another portion of the adapter 101 may be configured to engage or connect with, or hold, at least a portion of the legs or bars of the lower support member 12 of the lift 14.

In accordance with embodiments of the present invention, the bottom side 112 of the adapter base 110 may be substantially flat and may comprise one or more connection points, for example, one or more openings or sockets (not shown) adapted to optionally receive one or more pegs 9 of the lift base 11, to support connection of the adapter base 110 to the lift base 11. In accordance with embodiments of the present invention, the adapter base 110 may be used alone or in conjunction with the lift base 11. For example, in some embodiments, the adapter base 110 may be configured to mount on or otherwise connect to the lift base 11, whereas in some embodiments, the adapter base 110 may be a standalone component which may be configured to support the weight of the adapter component and/or the lift device 100 connected thereto.

In accordance with embodiments of the present invention, the top side 113 of the adapter base 110 may comprise a lift base connector portion 114 and one or more adapter body connector portions 115, for example, a pair of adapter body connector portions 115. In some examples, the base connector portion 114 and the one or more adapter connector portions 115 may protrude from a top side 113 of the adapter base 110.

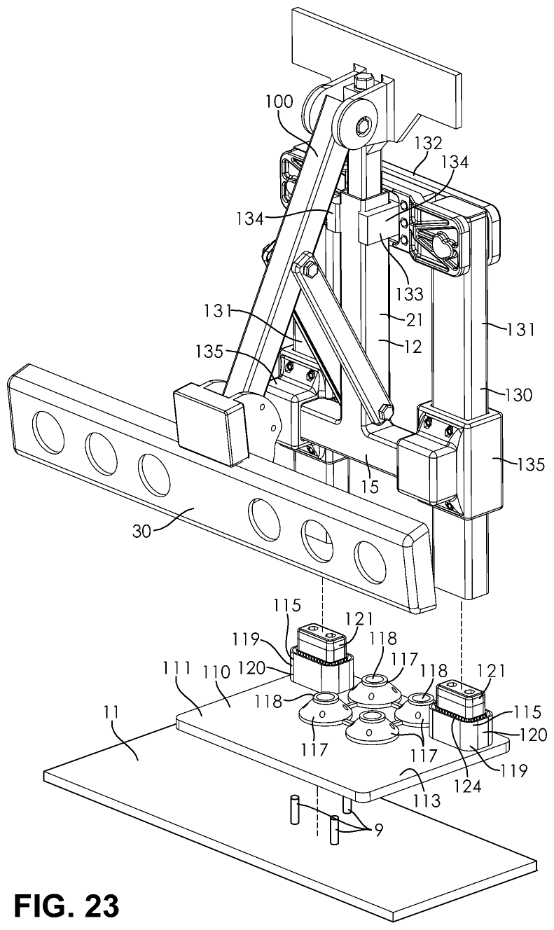

FIG. 23 depicts a partially exploded view of an exemplary lift and adapter assembly. As shown in FIG. 23, the lift base connector portion 114 may comprise one or more connector components 117, for example, four connector components 117, which protrude from the adapter base 110, each connector component 117 comprising a hollow opening 118 configured to receive and/or retain the pegs 9 of the lift base plate 11. In some examples, each connector component 117 may be integrally formed with the platform element 111 of the adapter base, or may be permanently or removably attached to the platform element 111, for example, by means of adhesives, screws, pins, and any other permanent or removable attachment means. In some examples, the openings or sockets (not shown) of the adapter base bottom side 112 may extend towards (e.g., lead to) the lift base connector portion 114, for example, to the one or more connector components 117 which may protrude from the top side 113 of the adapter base 110.

In accordance with embodiments of the present invention, the adapter base 110 may comprise a predetermined amount of sockets (not shown) and/or connector components 117. For example, the adapter base 110 may comprise sockets (not shown) and/or connector components 117 corresponding to the number of pegs 9 in the lift base plate 11. In some examples, the sockets (not shown) and/or connector components 117 may be less than or may exceed the number of pegs 9 in the lift base plate 11. In some examples, the connector components 117 may be standalone components or may connected to (e.g., attached to or integrally formed with) one or more additional connector components 117, for example, to improve stability of the connection between the adapter base 110 and the lift base plate 11. In some examples, the connector components 117 and/or sockets (not shown) may be generally cylindrical, however, in any embodiment, the connector components 117 and/or sockets (not shown) may be formed in any shape suitable to have a hollow opening and/or channel disposed therein for supporting connection to the lift base plate 11.

In accordance with embodiments of the present invention, the adapter connector portions 115 may protrude from the top side 113 of the adapter base 110. In some examples, the adapter connector portions 115 may comprise one or more, for example, two, protruding connector elements 119, for example, sequentially layered according to size (e.g., larger to smaller). In some examples, the protruding connector elements 119 may be substantially rectangular (e.g., rectangular prisms) and may have rounded corners. In scenarios with two protruding connector elements 119, the protruding connector elements may be arranged with, for example, a first protruding connector element 120 protruding from the top surface 113 of the adapter base 110, and a second, smaller protruding connector element 121, protruding from a top surface of the first protruding connector element 120. In some examples, a slot or groove 124 may be formed between a first protruding connector element 120 and a second protruding connector element 121 and may be adapted to receive an end portion of an arm element 131. For example, a generally hollow arm element 131 may comprise a thin-walled and substantially rectangular end portion (with optional rounded corners) which may be configured to correspond to, and fit within, the slot or groove 124 formed between the first and second protruding connector elements 120, 121 to support securement of an arm element 131 to an adapter connector portion 115 (e.g., such a thin-walled substantially hollow end portion of the arm element 131 may fit snugly within the slot or groove 124 on the adapter connector portion 115 to support securement of the arm element 131 to the adapter base 110). In any embodiment, the protruding connector elements 119 may be generally rectangular (e.g., rectangular prism) or may have any other suitable three-dimensional shape, including cylindrical, cube, hexagonal, ovular, spherical, or any other similarly suitable three-dimensional shape. In some embodiments, the protruding connector elements 119, for example, a second protruding connector element 121, may comprise connector pins and/or receiving holes corresponding to receiving holes and/or connector pins disposed on the arm elements. For example, as shown in the depicted example, a protruding connector element 119 may comprise one or more, for example, two, receiving holes 123 configured to support attachment of the adapter body 130 to the adapter connector portions 115, for example, by corresponding in shape to and adapted to be received by corresponding connector pins (not shown) disposed on the arm elements 131. In some scenarios, as shown in the illustrated example, the receiving holes 123 may be substantially hexagonal in shape, however, in any embodiment, the receiving holes 123 may have any other similarly suitable shape, including circular, ovular, square, rectangular or any other shape. Alternatively or additionally, for example, the adapter connector portions 115 may comprise one or more connector pins configured to support attachment of the adapter body 130 to the protruding connector elements 119, for example, by corresponding in shape to and adapted to be received by receiving holes disposed on the arm elements 131. In some examples, connector pins may comprise a substantially cylindrical body portion and a substantially rounded top portion, and may protrude from and/or may be formed with or otherwise connected to the protruding connector elements. In any embodiment, the connector pins may be any similarly suitable shape, for example, rectangular, hexagonal, or square shapes. In preferred embodiments, the connector pins and receiving holes correspond to each other in shape. In some scenarios, the receiving holes and/or connector pins may comprise magnet members or other similarly suitable ferromagnetic materials adapted to support connection between corresponding receiving holes and connector pins.

In accordance with embodiments of the present invention, the adapter body 130 may comprise one or more arm elements 131 and one or more bridge elements 132. As shown in the depicted example, in some embodiments, a pair of arm elements 131 may be connected by a bridge element 132 to form a generally U-shape. In some embodiments, the arm elements 131 may be substantially rectangular elongated blocks. In some embodiments, the arm elements 131 may be substantially hollow. In any embodiment, the arm elements 131 may be formed in any other similarly suitable shape, for example, a generally cylindrical or any other geometrically suitable shape.

In accordance with embodiments of the present invention, the bridge element 132 may comprise one or more lift fastening means 133. In some embodiments, the lift fastening means 133 may be a clamp implement, a snap locking implement, a pressure fit implement, a magnet implement, or any combination of the foregoing. For example, the lift fastening means 133 may comprise a pair of opposing members 134 forming a clamp. In some examples, the opposing members 134 may have an over-hanging portion and may be biased or tensioned towards one another to support securement of the lower support member of a lift to the bridge element 132. The lift fastening means 133 may be configured to support connection of the adapter body 130 to the lift device 100, for example, at the lower support member 12 of the lift device 100. In some examples, the lift fastening means 133 may be a bracket member, a clamp member or snap locking member adapted to clamp, bracket, or snap fasten the lower support member 12 of the lift device 100 to the bridge element 132 of the adapter body 130.

In accordance with embodiments of the present invention, the adapter body 130 may comprise a pair of arm elements 131 operably connected to a bridge element 132, which may comprise a pair of opposing bridge plates 139. In some examples, the bridge plates 139 of the bridge element 132 may be releasably or permanently connected to one another, for example, by means of adhesives, screws, pins, or any other releasable or permanent attachment means. In the depicted example, at least a portion of the bridge plates 139 are connected to one another by means of screws 138. In some examples, the arm elements 131 may be pivotally connected to the bridge element 132. For example, a top portion of each arm element 131 may be pivotally connected to an end of the bridge element 132 via a pivoting mechanism disposed between the pair of opposing bridge plates 139. In some examples, a pivoting mechanism may comprise a slot, or series of slots, in the arm elements and a pin configured to travel in the slot(s) formed in the arm elements 131. In some examples, the slot(s) may be “L” shaped, or any other shape. In an illustrative example, a pin disposed between opposing bridge plates 139 of a bridge element 132 may be configured to travel in an “L” shaped slot formed in an arm element 131, to support pivoting of an arm element 132 about an axis formed at an end of the bridge element 132. The range of movement of the pin(s) disposed at the ends of the bridge element 132 and/or the bridge plates 139 may be defined by the slots formed at the top ends of the arm elements 131. In some examples, the opposing sidewalls of an arm element 131 may be configured to rotate between opposing sidewalls of a bridge element 132. In some embodiments, the bridge element 132 may be pivotally engaged with the arm elements 131, for example, through the use of screws, pins, or any other similarly suitable pivoting means, for example, capable of operating as a rotational axis for a portion of an arm element 131 disposed between the bridge plates 139. In some examples, the pivoting mechanism may comprise a ratcheting mechanism configured to selectively lock the arm elements 131 in one to a plurality of positions relative to the bridge element 132. In some examples, the bridge element 132 may be configured to connect to (e.g., releasably and/or permanently) a top portion of the arm elements 131. For example, the bridge element 132 may connect a first arm element 131 to a second arm element 131 at their respective top portions. In any embodiment, the bridge element 132 may connect the arm elements 131 at any other portion of the arm elements 131, for example, at a middle portion or a bottom portion of the arm elements 131.

In accordance with embodiments of the present invention, the adapter body 130 may comprise a pair of arm elements 131. In some examples, each arm element 131 may be an elongated block, and may comprise a cavity or opening extending toward a hollow internal channel, and a leg retaining member 135 configured to retain a portion of a lower support member 12 of a lift device 100. In some examples, the leg retaining members 135 may be configured to retain an end portion of at least one of the legs (e.g., a first leg 15) of the lower support member 12 of the lift device 100. In some examples, a lift leg retaining member 135 may be releasably or permanently connected to an arm element 131, for example, by use of pins, screws, adhesives (e.g., glue), or other similarly suitable releasable or permanent attachment means. In some examples, the position of the leg retaining members 135 may be fixed with respect to the arm elements 131, or may be movable and/or adjustable with respect to (e.g., along) the arm elements 131. In the depicted example, the lift leg retaining members 131 connect to the arm elements 131 by means of screws. In some embodiments, the leg retaining members 135 may be configured to house an end portion of the lower support member legs or bars (e.g., an end of a first leg 15 of the lower support member 12). In some examples, a leg retaining member 135 may include a fastening means to fasten an end portion of a leg or bar of the lower support member 12 to the leg retaining members 135. For example, a pair of leg retaining members 135 may each comprise cavities configured to receive and retain and/or secure of an end portion of the first leg 15 of the lower support member 12. In some examples, the leg retaining members 135 may comprise an opening 136 extending towards a channel configured to receive and/or retain an end portion of the at least one of the legs of the lower support member 12. In some examples, the opening and/or channel 136 may substantially correspond in shape to an end portion of a leg of the lower support member 12, for example, the opening and/or channel 136 may be substantially square or rectangular shaped to accommodate a leg or bar of the lower support member 12. In some examples, an end portion of a leg of the lower support member 12 may snap fit or pressure fit in a channel of a leg retaining member 135. In some examples, a portion of the channel of the leg retaining member 135 may comprise a magnet or similar ferromagnetic member adapted to engage with a portion of the leg or bar of the lower support member 12 to support connection of the components. In some examples, any similar fastening mechanism may be utilized to secure the leg retaining members 135 to the end portions of the legs of the lower support member 12.

In accordance with embodiments of the present invention, the adapter body 130 may be a singular component (e.g., integrally formed with the arm elements 131 and/or the bridge element 132). In some embodiments, the adapter body 130 may comprise several individual components attached together (either permanently or releasably).

As demonstrated in FIGS. 21-23, the adapter body 130 may be configured to connect to the lift device 100 at or near at least two sections of the lift device 100, for example, at a first section of the lower support member 12 and at a second section of the lower support member 12. In some examples, a first section of the lower support member 12, for example, a first leg of a T-shaped lower support member 12, may connect to the bridge element fastening means 133 at the bridge element 132, for example, at one connection point on the bridge element 132, and a second section of the of the lower support member 12, for example, a second leg of a T-shaped lower support member 12 may connect to the arm elements 131 of the adapter body 130 at one or more connection points, for example, at one or more leg retaining members 135 disposed on the arm elements 131. In some examples, a leg of the lower support member 12 may connect to the arm elements 131 of the adapter body 130 by means of a pair of leg retaining members 135, each leg retaining member 135 disposed on each arm element 131.

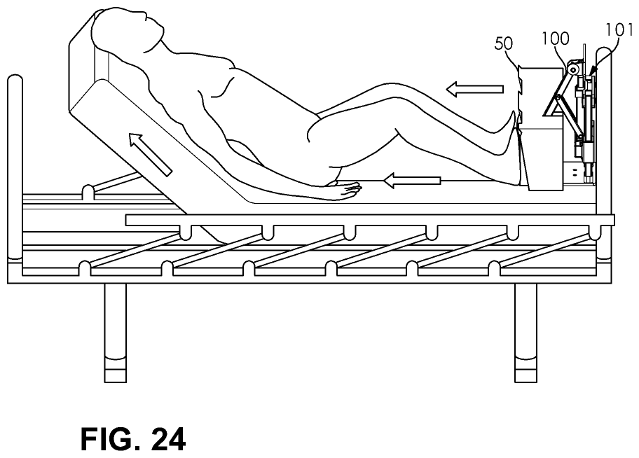

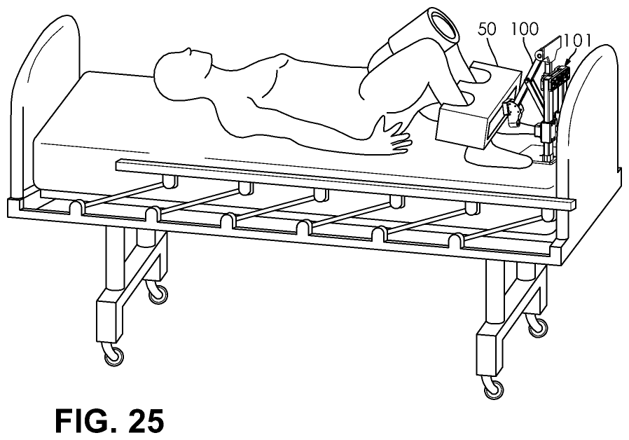

In an exemplary usage scenario, the lift and positioning device 100 may be utilized by placing the front base 11 and rear base 5 of the device 100 on the footboard of a bed so that the device 100 may be used to expand towards a patient's feet. As shown in FIGS. 24-25, in some examples, an adapter 101 may be utilized to support the change in the orientation of the lift device 100, for example, to change the lift 14 from being applied to move a body part or person along a vertical axis (e.g., up and down), to being applied to move a body part or person along a horizontal axis (e.g., side to side). In any embodiment, the lift device 100 may be utilized in a horizontal orientation with or without the adapter 101.

Further in an exemplary usage scenario, the device 100 may be expanded to lift, prop, or otherwise re-position a patient by rotating or tightening the screw 8 disposed at the rear section of the lower support member 12. For example, rotating the screw 8 engages the internal threads of the internal chamber 26, to draw the screw 8 towards the front section of the lower support member 12, such that the internal shaft 24 is likewise drawn towards the external shaft 21 to decrease the distance between the rear base 5 and the front base 11. In some embodiments, drawing the rear base 5 towards the front base 11 in this manner directs the lever arm 17 upwards as a result of its pivotable connection to the pivot module 3 and the bracket members 27. In some scenarios, the height of the device 100 directly correlates to the extent the screw 8 is inserted into the internal chamber 26 of the second leg 21. The device 100 is in an expanded position (as shown in FIG. 1) when the screw 8 is inserted into the lower support member 12 and the lever arm 17 is elevated and angled away from the front base 11.

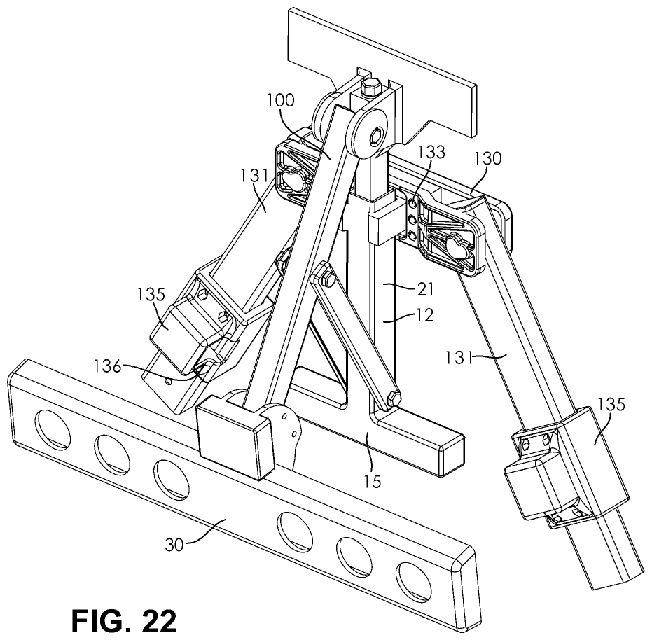

In accordance with an exemplary usage scenario, the adapter body 130 may be configured to move to a first position and to a second position. In some embodiments, a first position of the adapter body may be an open position (as shown, for example, in FIGS. 20 and 22) and a second position may be a closed position (as shown, for example, in FIGS. 19, 21, and 23). In any embodiment, the adapter body may be moved anywhere between the open and closed positions, including a partially open and/or closed position.

In accordance with an exemplary usage scenario, an adapter 101 may be utilized in conjunction with a lift device 100 to change the orientation of the lift device 100, for example, to change the application of the device from being utilized to move a body part or person along a vertical axis (e.g., up and down), to being utilized to move a body part or person along a horizontal axis (e.g., side to side). In some examples, a user may connect a portion of the second leg 21 of the lift device 100 to the fastening means 133 on the bridge element 132. In examples with a clamp implement as the fastening means 133, a portion of the second leg 21 may be inserted between the pair of tensioned protruding portions 134 forming the clamp to retain the second leg 21 of the lower support member 12 of the lift 100. As shown in FIGS. 20 and 22, in some examples, each arm element 131 may be pivoted along a rotational axis with respect to the bridge element to enable movement of the arm members relative to the bridge element, for example, to increase or decrease the distance between the respective bottom portions of the arm elements (e.g., to move the adapter body from a first position to a second position and vice versa). In some examples, in an open position of the adapter body (as shown, for example, in FIGS. 20 and 22), the distance between the respective bottom portions of the arm elements may be increased, whereas in a closed position, the distance between the respective bottom portions of the arm elements may be decreased (as shown, for example, in FIGS. 19, 21, and 23). In some examples, the adapter body 130 may be moved to an open position to make it easier or more convenient to insert the end portions of the first leg 15 into the openings/channels 136 of the leg retaining members 135. In some scenarios, a first end of the first leg 15 may be inserted into an opening/channel in a first leg retaining member 135, and subsequently, a second end of the first leg 15 may be inserted into an opening/channel in a second leg retaining member. Alternatively or additionally, the leg retaining members may be simultaneously placed on the respective ends of the first leg 15, or placed on the respective ends of the first leg 15 in a different order. In some examples, the arm elements 131 may be detached from the bridge element 132 to support securement of the leg retaining members 135 to the first leg 15 of the lower support member 12.

In some examples, the fastening means 133 of the bridge element 132 may be connected to the second leg 21 of the lift 100, and the cavities/channels of the leg retaining members may connect to each end of the first leg member 15. In such a configuration, the adapter body 130, including the bridge element 132 and the arm elements 131, may form a generally U-shape.

In some examples, once the adapter body is connected to the lower support member 12 of the lift 100, the bottom ends of the arm elements may connect to the adapter connector portions of the adapter base. In some examples, one or more protruding connector elements 119 of the adapter connector portions 115 may be inserted into an opening of the arm elements 131 to connect the arm elements 131 to the adapter connector portions 115 and the thin-walled end portion of the arm elements 131 may be inserted into the slot/groove formed in the adapter connector portions 115.

In some examples, once the adapter body 130 is connected to (e.g., installed on) the adapter base 110, the adapter base 110 may optionally be connected to the lift base plate 11 to provide additional support to the horizontal use assembly. The adapter base may connect to the lift base plate 11 by means of the pegs of the base plate 11 connecting to the lift base connector portions 114, for example, being inserted into the sockets 116 and/or connector components 117 at the bottom side of the adapter base 110.

FIG. 24 demonstrates an exemplary usage scenario of the horizontal use assembly. In accordance with an exemplary usage scenario, a horizontal use assembly may comprise a lift 100 and an adapter 101 and may assist in preventing slouching of users (e.g., patients) and/or to assist in user (e.g., patient) self-adjustment. In some examples, the horizontal use assembly may prevent users (e.g., patient) from gravity-sliding on inclined, adjustable mattresses by providing users (e.g., patients) with a designated foot platform (e.g., a precisely placed foot platform). This may allow a user (e.g., a patient) to self-adjust, for example, without summoning and/or straining healthcare personnel (e.g., nurses). In some examples, a horizontal use assembly may be brought into a patient room periodically for patient leg thrusting or left in place for constant self-adjustment by the patient.

FIG. 25 demonstrates another exemplary usage scenario of the horizontal use assembly. In accordance with an exemplary usage scenario, a horizontal use assembly may comprise a lift and an adapter 101 and may assist in lower back decompression. In the depicted example, the horizontal use assembly (e.g., including a cushion, a lift and an adapter) are placed in between a user (e.g., a patient) shins and a footboard. As demonstrated in FIG. 25, in some scenarios, a person (e.g., healthcare personnel) may place the horizontal use assembly against the foot of a bed with the cushion facing a user (e.g., a patient). The person (e.g., health personnel) may then use a socket end of a lift driver that may be attached to a driving bolt at the end of the lift to move the lower cushion until it touches the user's (e.g., the patient's) shins, just below the knee, to decompress the user's (e.g., the patient's) lower back. Healthcare personnel and/or a user may then alternate between compressing or decompressing and allowing for knees-bent healing or stretch therapy.

In accordance with embodiments of the present invention, the angle of the cushion mount 30 of the lift 100 may be radially adjusted by adjusting the angle of the mount joint 35. To radially adjust the joint 35, a user may remove the lock pin 49 inserted into the side walls 41 of the mount 35 and the top portion of the lever arm 17 and rotating the mount 35 to a selected or desired position and inserting the lock pin 49 into the holes in the side walls 41 and the lever 17 which correspond to the desired new position.

In some embodiments, a cushion 50 may be installed upon the mount 30 by pressing the cushion 50 onto the mount 30, for example, by pressing or pushing on the cushion 50 to direct the one or more protrusions disposed on the bottom of the cushion 50 into the slots or hollow spaces 37 disposed on the mount 30. This configuration aids in the easy attachment and securement of a cushion or cushions 50 to the mount 30 without the need for bolts, pins, snaps or ties that make assembly complex and time consuming.

As shown in the exemplary usage scenarios depicted in FIGS. 15-18, a plurality of cushion(s) 50 may each be respectively dimensioned to accommodate a side laying or back laying person's back, torso, shoulder, hips and legs, and feet wherein at least one curved cushion(s) adjoined to a mount 30 rests upon a specified and targeted patient body part. A nurse or any patient attendant may reposition and secure the laying person into a series of desired body positions using a system comprised of a lift or modified mechanical jack 14 and the adjoining mount 30 and interchangeable cushion(s) 50. An attendant may reposition a patient, for example, a bedridden person, by using the lift 14, adjoining mount 30 and cushion(s) 50 to reposition, prop and secure the laying patient from a supine or prone laying position into a new position wherein one or more body parts are lifted, raised and secured by the device 100. Once set, the device 100 may prevent a patient from moving from side-to-side, rolling or otherwise shifting into an undesired position.

In an exemplary embodiment, a body lift and positioning device 100 and methods of use, the apparatus including a base 11, a joint 35, for example, a radial adjustment head, a mechanical jack or “lift” 14, a mount 30 and one or more cushion(s) 50 dimensioned to conform and contour to a particular patient body part thereon. The method including the steps of providing a body lift and positioning apparatus 100, the apparatus having a base 11 capable of moving, for example, sliding, on a bed, a mechanical jack 14 capable of being lifted and lowered by means of a rotational device, for example, a socket driver, and contoured cushion(s) 50 configured to fit a particular body part of a person, for example, an immobile or obese patient.

In still a further exemplary embodiment of the invention the cushion(s) 50 may be contoured to fit underneath a patient's back. In some embodiments of the invention a plurality of cushions 50 may be fitted onto one another and configured to conform to a patient's torso to enable the patient to tilt sideways.

In some examples, for purposes of easy and convenient storage and transport the cushions 50 may seat into each other making it possible to move many body parts yet still fit the cushions 50 in a duffel bag. In some embodiments of the invention a plurality of cushions 50 may be fitted into one another and configured to conform to the bottom of a patient's legs to aid in circulation by raising the legs above the heart. In yet another embodiment of the invention one or more cushions 50 may be fitted in order to facilitate propping a patient on their side to aid in changing bed pans.

In accordance with embodiments of the present invention, the cushions 50 may be approximately twenty to twenty-six inches in width.

In a method of assembly of an exemplary embodiment of the device 100, an attendant may attach the bottom of the lift 14 to pegs 9 resting on the top portion of a base plate 11 at 90-degree angles. The lift 14 may be attached to the base plate 11 and the joint or radially adjustable accepter head 35 may be attached to the end of the lift's lever arm by the use of pins or carriage bolts 49. The cushion mount or cradle 30 may give a cushion 50 strength and stability in addition to a hard upper platform to be inserted into the lift 14 and an angle may be selected for the cradle by way of the joint 35 using a pin 49. In some embodiments, the upper platform of the mount or cradle 30 may include slots or cavities 37 configured to receive protrusions or columns extending from the cushions 50 to secure the cushions 50 to the cradle or mount. For example, the cushion or plurality of cushions 50 may be fitted together and attached to the cushion cradle 30 by way of columns at the bottom of the cushions that fit into the slots or cavities 37 in the cradle 30 for a snug fit. In some scenarios, an attendant may select the appropriate cushion or plurality of cushions 50 for use. The attendant or attendants may reposition the device 100 across the support surface, for example, a bed, and place it partially underneath and/or adjacent to the body part that the attendant wishes to lift and prop. The attendant or attendants may then manually move the patient or patient body part using a strap or sling or by means of their hands alone. The movement required however, will be minimal since the body part may be placed upon the lowest setting of the lift 14. Once the base 11, lift 14, joint 35, mount 30 and appropriate cushion(s) 50 are assembled, the attendant may place the appropriate patient body part or parts into the appropriate cushion(s) 50 and then, using a rotational device, for example, a powered socket driver, lift the patient's body part to any desired height within the range of the lift's capabilities.

Accordingly, at least one feature of the medical lift and positioning device and methods of use is its ability to enable a single attendant to comfortably maneuver, reposition, roll, lift and/or prop a body part of a large bedridden patient with no other tool needed. In some embodiments, only a strap, for example, a dual clamp locking strap attached to a footboard to form a loop, may be needed to comfortably maneuver, reposition, roll, lift and/or prop a body part of a large bedridden patient. The device itself may be designed for such ease of maneuverability.

In some embodiments, multiple devices 100 may be used to lift and prop more than one patient body part at a time.

In some embodiments, the device 100 provides an efficient, lightweight, highly maneuverable and safe apparatus for the lifting, propping and repositioning of patients, for example, bedridden patients.

In some embodiments, the device 100 enables a single person to quickly and/or efficiently prop a person, for example, a bedridden patient, on either of the patient's sides to maintain patient comfort, facilitate patient examination, and to prevent bed sores from forming.

In some embodiments, the device 100 provides a compact, disassemble able, light and portable apparatus that may be easily stored and transported to a patient's home or hospital room.

In some embodiments, the device 100 assists with bedridden patient rolling, positioning, repositioning, and tilting a bedridden patient from side-to-side and may position, reposition and tilt a particular body part of a patient at various angles between the horizontal and vertical axis.

In some embodiments, the device 100 relieves stress on the fingers, hands, arms, back, shoulders and wrists of the caregiver, especially when the patient is heavy.

In some embodiments, the device 100 accommodates different sized bedridden patients, for example, by use of different sized cushions.

In some embodiments, device 100 and/or the cushions 50 may include one or more limb fastening straps, for example Velcro® straps. In some situations, the limb fastening straps may be utilized to hold a limb, for example, an arm, in place on the cushion 50.

In some embodiments, the device 100 conform to a side laying patient's back, shoulder, torso, hips, and upper legs.

In some embodiments, the device 100 provides a low-cost alternative to systems for lifting, propping, securing and turning a bedridden patient, such as, mechanical means for lifting and turning, including mechanical rollers supported by a stationary or moveable support structure, for example, a heavy steel stationary or moveable support structure, positioned above a hospital bed.

In some embodiments, the device 100 provides a support assembly capable of supporting a patient, for example, a bedridden patient, in an angled position on their side to enable additional positions so that the patient may rest on his or her side to reduce bed sores and to increase comfort of the bedridden patient.

In some embodiments, the device 100 may be utilized with existing beds or bed frames.

In some embodiments, the device 100 may be easier, less expensive, smaller, more expandable, lighter and simpler to use than existing technology.

In some embodiments, the device 100 may be independent of attachment to a ceiling, wall or floor thereby making the device capable of being freely transported and capable of being used in a wide variety of environments, including, for example, on the ground to aid a bleeding soldier by elevating the bleeding injury above the soldier's heart.

In some embodiments, the device 100 is configured to be easy to assemble and disassemble and may fit under a bed, or in a duffel bag for easy transport.

While the present invention has been illustrated by a description of various embodiments and while these embodiments have been described in considerable detail, it is not the intention of the inventor to restrict or in any way limit the scope of the appended claims to such detail. The various features discussed herein may be used alone or in any combination. Additional advantages and modifications will readily appear to those skilled in the art. The invention in its broader aspects is therefore not limited to specific sizes, details, representative apparatus and methods, and illustrative examples shown and described. Accordingly, departures may be made from such details without departing from the spirit or the scope of the inventor's general inventive concept. The scope of the invention itself should only be defined by the following claims.

1. An adapter for a portable medical lift and positioning device, comprising:
A body member comprising a pair of arm elements, each arm element pivotally connected at a pivot point to a bridge element, the bridge element and arm elements each comprising at least one fastening means for retaining a portion of a lift device.

2. The adapter for a portable medical lift and position device of claim 1, wherein the bridge element fastening means comprises a bracket adapted to receive a portion of a lower support member of the lift device.

3. The adapter for a portable medical lift and position device of claim 1, wherein each arm element fastening means comprises openings extending toward channels, each channel adapted to friction fit a leg of a lower support member of the lift device.

4. The adapter for a portable medical lift and position device of claim 1, wherein the body member is operably connected to a base of the lift device.

5. An adapter for a portable medical lift and positioning device, comprising:
A body member, comprising:
a pair of arm elements, each arm element having an elongated structure with a lift retaining member disposed on a middle section of the elongated structure, each lift retaining member comprising an opening extending toward a channel configured to retain a front portion of a lift device, and a top section of each elongated structure pivotally joined to a bridge element comprising a fastening means adapted to receive at least a rear portion of the lift device.

6. The adapter for a portable medical lift and positioning device of claim 5, wherein the body member releasably connects to a base member configured to releasably connect to a lift base.

7. The adapter for a portable medical lift and positioning device of claim 5, wherein the adapter is configured to rest on a footrest of a bed and enables the lift device to move a user side to side.

8. The adapter for a portable medical lift and positioning device of claim 5, wherein the adapter is formed of a carbon fiber material.

9. An adapter for a portable medical lift and positioning device, comprising:
A body member, comprising:
a pair of arm elements, each arm element having an elongated structure with a lift retaining member disposed on a middle section of the elongated structure, each lift retaining member comprising an opening extending toward a channel configured to retain a front portion of a lift device, and a top section of each elongated structure pivotally joined to a bridge element comprising a fastening means adapted to receive at least a rear portion of the lift device; and
a base member comprising a pair of adapter connector portions and one or more openings extending toward corresponding lift base connector portions.

10. The adapter for a portable medical lift and positioning device of claim 9, wherein the front portion of the lift device is a front portion of a lower support member of the lift device.

11. The adapter for a portable medical lift and positioning device of claim 9, wherein the rear portion of the lift device is a rear portion of a lower support member of the lift device.

12. The adapter for a portable medical lift and positioning device of claim 9, wherein a lower support member of the lift device comprises two legs which intersect to form a “T” shape, and each lift retaining member is configured to receive a portion of a first support member leg, and the bridge element fastening means is configured to receive a portion of a second support member leg.

13. The adapter for a portable medical lift and positioning device of claim 9, wherein the bridge element fastening means is a clamp.

14. The adapter for a portable medical lift and positioning device of claim 9, wherein the bridge element fastening means is a bracket.

15. The adapter for a portable medical lift and positioning device of claim 9, wherein the portions of the first support member leg friction fit within each of the lift retaining members disposed on the arm elements.

16. The adapter for a portable medical lift and positioning device of claim 9, wherein a pair of receiving holes are disposed on a top surface of the adapter connector portions are configured to receive a pair of connector pins disposed on the arm elements.

17. The adapter for a portable medical lift and positioning device of claim 9, wherein the arm elements are thin-walled.

18. The adapter for a portable medical lift and positioning device of claim 17, wherein a slot formed on the adapter connector portions is configured to receive an end portion of the thin-walled arm elements.

19. The adapter for a portable medical lift and positioning device of claim 9, wherein the adapter is configured to rest on a footrest and enables the lift device to move a user side to side.

20. The adapter for a portable medical lift and positioning device of claim 9, wherein the adapter is formed of a carbon fiber material.
